(19) United States
(12) Patent Application Publication
(10) Pub. No.: US 2023/0004409 A1
(43) Pub. Date: Jan. 5, 2023

(54) User Interface with Configurable Specification of Related Data Sources

(71) Applicant: ServiceNow, Inc., Santa Clara, CA (US)

(72) Inventors: Sanjay Kumar Gupta, Santa Clara, CA (US); Vytesh Ramesh, Santa Clara, CA (US); Elizabeth Ilona Szeles, Santa Clara, CA (US); Shilpa Shree Rajashekara, Santa Clara, CA (US); Shankaraiah Onteru, Santa Clara, CA (US); Praneeth Konduri, Santa Clara, CA (US); Jitendra Kumar, Santa Clara, CA (US); Kavita Waldia, Santa Clara, CA (US); Duc Tuan Tran, Santa Clara, CA (US); Amanda Chaffee, Santa Clara, CA (US)

(21) Appl. No.: 17/365,170

(22) Filed: Jul. 1, 2021

(51) Int. Cl. G06F 9/451; G06F 9/448; G06N 20/00

(52) U.S. Cl. CPC G06F 9/452; G06F 9/4494; G06N 20/00

(57) ABSTRACT

Persistent storage contains a definition of a playbook and a plurality of subtasks for the playbook, wherein some of the subtasks are respectively associated with corresponding data sources that provide units of related information. One or more processors can: generate a representation of a graphical user interface including a menu pane, a subtask pane, and a related information pane, wherein the menu pane is populated with selectable objects representing the subtasks; receive an indication that a particular selectable object representing a particular subtask has been selected; determine that a particular data source corresponding to the particular subtask can provide a particular unit of the related information; obtain, from the particular data source, the particular unit of the related information; and update the representation to include details of the particular subtask in the subtask pane, and to include the particular unit of the related information in the related information pane.

### BACKGROUND

Modern user interfaces are often dynamically generated, with script-based components that retrieve information from a database and then provide this information for display. Nonetheless, these user interfaces are still limited, in that they frequently require the user to navigate between pages of information during common tasks. This results in users being more likely to lose track of where they are in these tasks, or at least the context for the subtask upon which they are working and/or the subtask's information. As a consequence, users tend to switch back and forth several times between pages, with dynamic information therein potentially being freshly loaded each time. Doing so places an unnecessary burden on processing power and memory utilization, not only on server devices that provide the information, but also on the databases that store this information.

### SUMMARY

The embodiments herein overcome these and potentially other technical problems by establishing a data-driven framework for dynamically displaying information related to subtasks within the overall context of a task (also referred to herein as a workflow or a playbook). An administrator may define one or more data sources per subtask, and information retrieved from these data sources may be displayed in a separate pane of a web page (or another form of user interface) guiding the user through the task. The data sources could be database tables, remote application programming interfaces (APIs), local files, machine learning models, etc. The number of data sources per subtask and the related content to obtain from these data sources can be dynamically defined.

With these embodiments in place, users are presented with task, subtask, and related information obtained from the specified data sources all in one web page rather than being split across two or more web pages. This reduces the number of times that a user switches between pages, as well as the number of times that the user refreshes these pages. This produces a commensurate reduction in computing resource utilization (e.g., processor, memory, and/or network) on the associated web server and data source.

Accordingly, a first example embodiment may involve generating, for display on a client device, a representation of a graphical user interface including a menu pane, a subtask pane, and a related information pane, wherein the menu pane is populated with a plurality of selectable objects representing a plurality of subtasks for a playbook, wherein persistent storage contains a definition of the playbook and the plurality of subtasks, and wherein at least some of the subtasks are respectively associated with corresponding data sources that can provide units of related information. The first example embodiment may also involve transmitting, to the client device, the representation of the graphical user interface. The first example embodiment may also involve receiving, from the client device, an indication that a particular selectable object of the plurality of selectable objects has been selected, wherein the particular selectable object represents a particular subtask of the plurality of subtasks. The first example embodiment may also involve determining that a particular data source corresponding to the particular subtask can be used to provide a particular unit of the related information. The first example embodiment may also involve obtaining, by way of the particular data source, the particular unit of the related information. The first example embodiment may also involve updating the representation of the graphical user interface to include details of the particular subtask in the subtask pane, and to include the particular unit of the related information in the related information pane. The first example embodiment may also involve transmitting, to the client device, the representation of the graphical user interface as updated.

In a second example embodiment, an article of manufacture may include a non-transitory computer-readable medium, having stored thereon program instructions that, upon execution by a computing system, cause the computing system to perform operations in accordance with the first example embodiment.

In a third example embodiment, a computing system may include at least one processor, as well as memory and program instructions. The program instructions may be stored in the memory, and upon execution by the at least one processor, cause the computing system to perform operations in accordance with the first example embodiment.

In a fourth example embodiment, a system may include various means for carrying out each of the operations of the first example embodiment.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

FIG. 1 illustrates a schematic drawing of a computing device, in accordance with example embodiments.

FIG. 2 illustrates a schematic drawing of a server device cluster, in accordance with example embodiments.

FIG. 3 depicts a remote network management architecture, in accordance with example embodiments.

FIG. 4 depicts a communication environment involving a remote network management architecture, in accordance with example embodiments.

FIG. 5A depicts another communication environment involving a remote network management architecture, in accordance with example embodiments.

FIG. 5B is a flow chart, in accordance with example embodiments.

FIG. 6 depicts a logical hierarchy for a task, its subtasks, and associated data sources, in accordance with example embodiments.

FIG. 7 depicts a tabbed graphical user interface layout based on the logical hierarchy of FIG. 6, in accordance with example embodiments.

FIG. 8A depicts a possible implementation of the tabbed graphical user interface layout of FIG. 7 with a first tab selected, in accordance with example embodiments.

FIG. 8B depicts a possible implementation of the tabbed graphical user interface layout of FIG. 7 with a second tab selected, in accordance with example embodiments.

FIG. 9 depicts an improved logical hierarchy for a task, its subtasks, and associated data sources, in accordance with example embodiments.

FIG. 10 depicts an improved graphical user interface layout based on the logical hierarchy of FIG. 9, in accordance with example embodiments.

FIG. 11A depicts a possible implementation of the graphical user interface layout of FIG. 10, in accordance with example embodiments.

FIG. 11B depicts a possible implementation of the graphical user interface layout of FIG. 10 with a menu selected, in accordance with example embodiments.

FIG. 12 depicts a specific implementation of the graphical user interface layout of FIG. 10, in accordance with example embodiments.

FIG. 13A depicts a database schema to support the graphical user interface layout of FIG. 10, in accordance with example embodiments.

FIG. 13B depicts a specific example using the database schema of FIG. 13A in use, in accordance with example embodiments.

FIG. 13C depicts a script, in accordance with example embodiments.

FIG. 14 is a flow chart, in accordance with example embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features unless stated as such. Thus, other embodiments can be utilized and other changes can be made without departing from the scope of the subject matter presented herein.

Accordingly, the example embodiments described herein are not meant to be limiting. It will be readily understood that the aspects of the present disclosure, as generally described herein, and illustrated in the figures, can be arranged, substituted, combined, separated, and designed in a wide variety of different configurations. For example, the separation of features into “client” and “server” components may occur in a number of ways.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

### I. INTRODUCTION

A large enterprise is a complex entity with many interrelated operations. Some of these are found across the enterprise, such as human resources (HR), supply chain, information technology (IT), and finance. However, each enterprise also has its own unique operations that provide essential capabilities and/or create competitive advantages.

To support widely-implemented operations, enterprises typically use off-the-shelf software applications, such as customer relationship management (CRM) and human capital management (HCM) packages. However, they may also need custom software applications to meet their own unique requirements. A large enterprise often has dozens or hundreds of these custom software applications. Nonetheless, the advantages provided by the embodiments herein are not limited to large enterprises and may be applicable to an enterprise, or any other type of organization, of any size.

Many such software applications are developed by individual departments within the enterprise. These range from simple spreadsheets to custom-built software tools and databases. But the proliferation of siloed custom software applications has numerous disadvantages. It negatively impacts an enterprise's ability to run and grow its operations, innovate, and meet regulatory requirements. The enterprise may find it difficult to integrate, streamline, and enhance its operations due to lack of a single system that unifies its subsystems and data.

To efficiently create custom applications, enterprises would benefit from a remotely-hosted application platform that eliminates unnecessary development complexity. The goal of such a platform would be to reduce time-consuming, repetitive application development tasks so that software engineers and individuals in other roles can focus on developing unique, high-value features.

In order to achieve this goal, the concept of Application Platform as a Service (aPaaS) is introduced, to intelligently automate workflows throughout the enterprise. An aPaaS system is hosted remotely from the enterprise, but may access data, applications, and services within the enterprise by way of secure connections. Such an aPaaS system may have a number of advantageous capabilities and characteristics. These advantages and characteristics may be able to improve the enterprise's operations and workflows for IT, HR, CRM, customer service, application development, and security.

The aPaaS system may support development and execution of model-view-controller (MVC) applications. MVC applications divide their functionality into three interconnected parts (model, view, and controller) in order to isolate representations of information from the manner in which the information is presented to the user, thereby allowing for efficient code reuse and parallel development. These applications may be web-based, and offer create, read, update, and delete (CRUD) capabilities. This allows new applications to be built on a common application infrastructure.

The aPaaS system may support standardized application components, such as a standardized set of widgets for graphical user interface (GUI) development. In this way, applications built using the aPaaS system have a common look and feel. Other software components and modules may be standardized as well. In some cases, this look and feel can be branded or skinned with an enterprise's custom logos and/or color schemes.

The aPaaS system may support the ability to configure the behavior of applications using metadata. This allows application behaviors to be rapidly adapted to meet specific needs. Such an approach reduces development time and increases flexibility. Further, the aPaaS system may support GUI tools that facilitate metadata creation and management, thus reducing errors in the metadata.

The aPaaS system may support clearly-defined interfaces between applications, so that software developers can avoid unwanted inter-application dependencies. Thus, the aPaaS system may implement a service layer in which persistent state information and other data are stored.

The aPaaS system may support a rich set of integration features so that the applications thereon can interact with legacy applications and third-party applications. For instance, the aPaaS system may support a custom employee-onboarding system that integrates with legacy HR, IT, and accounting systems.

The aPaaS system may support enterprise-grade security. Furthermore, since the aPaaS system may be remotely hosted, it should also utilize security procedures when it interacts with systems in the enterprise or third-party networks and services hosted outside of the enterprise. For example, the aPaaS system may be configured to share data amongst the enterprise and other parties to detect and identify common security threats.

Other features, functionality, and advantages of an aPaaS system may exist. This description is for purpose of example and is not intended to be limiting.

As an example of the aPaaS development process, a software developer may be tasked to create a new application using the aPaaS system. First, the developer may define the data model, which specifies the types of data that the application uses and the relationships therebetween. Then, via a GUI of the aPaaS system, the developer enters (e.g., uploads) the data model. The aPaaS system automatically creates all of the corresponding database tables, fields, and relationships, which can then be accessed via an object-oriented services layer.

In addition, the aPaaS system can also build a fully-functional MVC application with client-side interfaces and server-side CRUD logic. This generated application may serve as the basis of further development for the user. Advantageously, the developer does not have to spend a large amount of time on basic application functionality. Further, since the application may be web-based, it can be accessed from any Internet-enabled client device. Alternatively or additionally, a local copy of the application may be able to be accessed, for instance, when Internet service is not available.

The aPaaS system may also support a rich set of pre-defined functionality that can be added to applications. These features include support for searching, email, templating, workflow design, reporting, analytics, social media, scripting, mobile-friendly output, and customized GUIs.

Such an aPaaS system may represent a GUI in various ways. For example, a server device of the aPaaS system may generate a representation of a GUI using a combination of HTML and JAVASCRIPT®. The JAVASCRIPT® may include client-side executable code, server-side executable code, or both. The server device may transmit or otherwise provide this representation to a client device for the client device to display on a screen according to its locally-defined look and feel. Alternatively, a representation of a GUI may take other forms, such as an intermediate form (e.g., JAVA® byte-code) that a client device can use to directly generate graphical output therefrom. Other possibilities exist.

Further, user interaction with GUI elements, such as buttons, menus, tabs, sliders, checkboxes, toggles, etc. may be referred to as “selection”, “activation”, or “actuation” thereof. These terms may be used regardless of whether the GUI elements are interacted with by way of keyboard, pointing device, touchscreen, or another mechanism.

An aPaaS architecture is particularly powerful when integrated with an enterprise's network and used to manage such a network. The following embodiments describe architectural and functional aspects of example aPaaS systems, as well as the features and advantages thereof.

### II. EXAMPLE COMPUTING DEVICES AND CLOUD-BASED COMPUTING ENVIRONMENTS

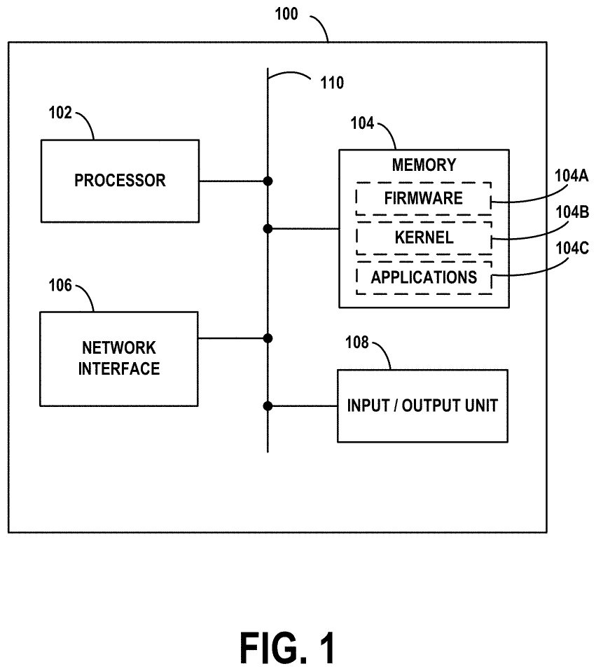

FIG. 1 is a simplified block diagram exemplifying a computing device 100, illustrating some of the components that could be included in a computing device arranged to operate in accordance with the embodiments herein. Computing device 100 could be a client device (e.g., a device actively operated by a user), a server device (e.g., a device that provides computational services to client devices), or some other type of computational platform. Some server devices may operate as client devices from time to time in order to perform particular operations, and some client devices may incorporate server features.

In this example, computing device 100 includes processor 102, memory 104, network interface 106, and input/output unit 108, all of which may be coupled by system bus 110 or a similar mechanism. In some embodiments, computing device 100 may include other components and/or peripheral devices (e.g., detachable storage, printers, and so on).

Processor 102 may be one or more of any type of computer processing element, such as a central processing unit (CPU), a co-processor (e.g., a mathematics, graphics, or encryption co-processor), a digital signal processor (DSP), a network processor, and/or a form of integrated circuit or controller that performs processor operations. In some cases, processor 102 may be one or more single-core processors. In other cases, processor 102 may be one or more multi-core processors with multiple independent processing units. Processor 102 may also include register memory for temporarily storing instructions being executed and related data, as well as cache memory for temporarily storing recently-used instructions and data.

Memory 104 may be any form of computer-usable memory, including but not limited to random access memory (RAM), read-only memory (ROM), and non-volatile memory (e.g., flash memory, hard disk drives, solid state drives, compact discs (CDs), digital video discs (DVDs), and/or tape storage). Thus, memory 104 represents both main memory units, as well as long-term storage. Other types of memory may include biological memory.

Memory 104 may store program instructions and/or data on which program instructions may operate. By way of example, memory 104 may store these program instructions on a non-transitory, computer-readable medium, such that the instructions are executable by processor 102 to carry out any of the methods, processes, or operations disclosed in this specification or the accompanying drawings.

As shown in FIG. 1, memory 104 may include firmware 104A, kernel 104B, and/or applications 104C. Firmware 104A may be program code used to boot or otherwise initiate some or all of computing device 100. Kernel 104B may be an operating system, including modules for memory management, scheduling, and management of processes, input/output, and communication. Kernel 104B may also include device drivers that allow the operating system to communicate with the hardware modules (e.g., memory units, networking interfaces, ports, and buses) of computing device 100. Applications 104C may be one or more user-space software programs, such as web browsers or email clients, as well as any software libraries used by these programs. Memory 104 may also store data used by these and other programs and applications.

Network interface 106 may take the form of one or more wireline interfaces, such as Ethernet (e.g., Fast Ethernet, Gigabit Ethernet, and so on). Network interface 106 may also support communication over one or more non-Ethernet media, such as coaxial cables or power lines, or over wide-area media, such as Synchronous Optical Networking (SONET) or digital subscriber line (DSL) technologies. Network interface 106 may additionally take the form of one or more wireless interfaces, such as IEEE 802.11 (Wifi), BLUETOOTH®, global positioning system (GPS), or a wide-area wireless interface. However, other forms of physical layer interfaces and other types of standard or proprietary communication protocols may be used over network interface 106. Furthermore, network interface 106 may comprise multiple physical interfaces. For instance, some embodiments of computing device 100 may include Ethernet, BLUETOOTH®, and Wifi interfaces.

Input/output unit 108 may facilitate user and peripheral device interaction with computing device 100. Input/output unit 108 may include one or more types of input devices, such as a keyboard, a mouse, a touch screen, and so on. Similarly, input/output unit 108 may include one or more types of output devices, such as a screen, monitor, printer, and/or one or more light emitting diodes (LEDs). Additionally or alternatively, computing device 100 may communicate with other devices using a universal serial bus (USB) or high-definition multimedia interface (HDMI) port interface, for example.

In some embodiments, one or more computing devices like computing device 100 may be deployed to support an aPaaS architecture. The exact physical location, connectivity, and configuration of these computing devices may be unknown and/or unimportant to client devices. Accordingly, the computing devices may be referred to as “cloud-based” devices that may be housed at various remote data center locations.

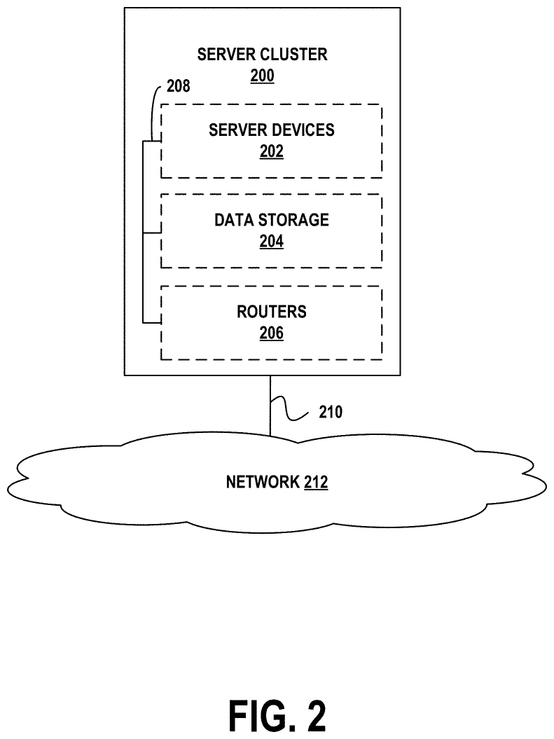

FIG. 2 depicts a cloud-based server cluster 200 in accordance with example embodiments. In FIG. 2, operations of a computing device (e.g., computing device 100) may be distributed between server devices 202, data storage 204, and routers 206, all of which may be connected by local cluster network 208. The number of server devices 202, data storages 204, and routers 206 in server cluster 200 may depend on the computing task(s) and/or applications assigned to server cluster 200.

For example, server devices 202 can be configured to perform various computing tasks of computing device 100. Thus, computing tasks can be distributed among one or more of server devices 202. To the extent that these computing tasks can be performed in parallel, such a distribution of tasks may reduce the total time to complete these tasks and return a result. For purposes of simplicity, both server cluster 200 and individual server devices 202 may be referred to as a “server device.” This nomenclature should be understood to imply that one or more distinct server devices, data storage devices, and cluster routers may be involved in server device operations.

Data storage 204 may be data storage arrays that include drive array controllers configured to manage read and write access to groups of hard disk drives and/or solid state drives. The drive array controllers, alone or in conjunction with server devices 202, may also be configured to manage backup or redundant copies of the data stored in data storage 204 to protect against drive failures or other types of failures that prevent one or more of server devices 202 from accessing units of data storage 204. Other types of memory aside from drives may be used.

Routers 206 may include networking equipment configured to provide internal and external communications for server cluster 200. For example, routers 206 may include one or more packet-switching and/or routing devices (including switches and/or gateways) configured to provide (i) network communications between server devices 202 and data storage 204 via local cluster network 208, and/or (ii) network communications between server cluster 200 and other devices via communication link 210 to network 212.

Additionally, the configuration of routers 206 can be based at least in part on the data communication requirements of server devices 202 and data storage 204, the latency and throughput of the local cluster network 208, the latency, throughput, and cost of communication link 210, and/or other factors that may contribute to the cost, speed, fault-tolerance, resiliency, efficiency, and/or other design goals of the system architecture.

As a possible example, data storage 204 may include any form of database, such as a structured query language (SQL) database. Various types of data structures may store the information in such a database, including but not limited to tables, arrays, lists, trees, and tuples. Furthermore, any databases in data storage 204 may be monolithic or distributed across multiple physical devices.

Server devices 202 may be configured to transmit data to and receive data from data storage 204. This transmission and retrieval may take the form of SQL queries or other types of database queries, and the output of such queries, respectively. Additional text, images, video, and/or audio may be included as well. Furthermore, server devices 202 may organize the received data into web page or web application representations. Such a representation may take the form of a markup language, such as the hypertext markup language (HTML), the extensible markup language (XML), or some other standardized or proprietary format. Moreover, server devices 202 may have the capability of executing various types of computerized scripting languages, such as but not limited to Perl, Python, PHP Hypertext Preprocessor (PHP), Active Server Pages (ASP), JAVASCRIPT®, and so on. Computer program code written in these languages may facilitate the providing of web pages to client devices, as well as client device interaction with the web pages. Alternatively or additionally, JAVA® may be used to facilitate generation of web pages and/or to provide web application functionality.

### III. EXAMPLE REMOTE NETWORK MANAGEMENT ARCHITECTURE

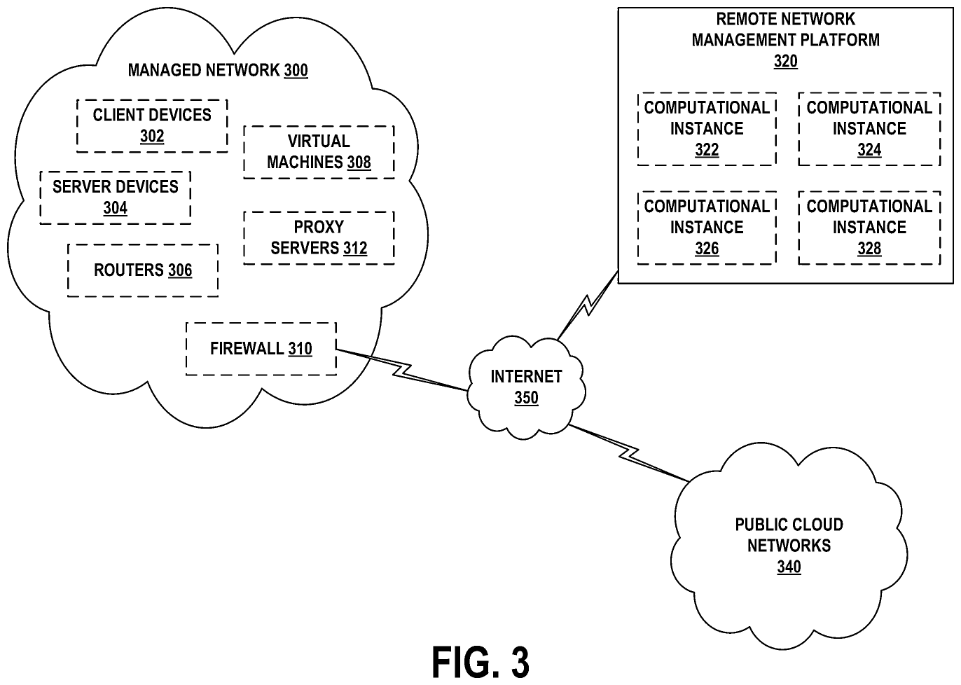

FIG. 3 depicts a remote network management architecture, in accordance with example embodiments. This architecture includes three main components—managed network 300, remote network management platform 320, and public cloud networks 340—all connected by way of Internet 350.

A. Managed Networks

Managed network 300 may be, for example, an enterprise network used by an entity for computing and communications tasks, as well as storage of data. Thus, managed network 300 may include client devices 302, server devices 304, routers 306, virtual machines 308, firewall 310, and/or proxy servers 312. Client devices 302 may be embodied by computing device 100, server devices 304 may be embodied by computing device 100 or server cluster 200, and routers 306 may be any type of router, switch, or gateway.

Virtual machines 308 may be embodied by one or more of computing device 100 or server cluster 200. In general, a virtual machine is an emulation of a computing system, and mimics the functionality (e.g., processor, memory, and communication resources) of a physical computer. One physical computing system, such as server cluster 200, may support up to thousands of individual virtual machines. In some embodiments, virtual machines 308 may be managed by a centralized server device or application that facilitates allocation of physical computing resources to individual virtual machines, as well as performance and error reporting. Enterprises often employ virtual machines in order to allocate computing resources in an efficient, as needed fashion. Providers of virtualized computing systems include VMWARE® and MICROSOFT®.

Firewall 310 may be one or more specialized routers or server devices that protect managed network 300 from unauthorized attempts to access the devices, applications, and services therein, while allowing authorized communication that is initiated from managed network 300. Firewall 310 may also provide intrusion detection, web filtering, virus scanning, application-layer gateways, and other applications or services. In some embodiments not shown in FIG. 3, managed network 300 may include one or more virtual private network (VPN) gateways with which it communicates with remote network management platform 320 (see below).

Managed network 300 may also include one or more proxy servers 312. An embodiment of proxy servers 312 may be a server application that facilitates communication and movement of data between managed network 300, remote network management platform 320, and public cloud networks 340. In particular, proxy servers 312 may be able to establish and maintain secure communication sessions with one or more computational instances of remote network management platform 320. By way of such a session, remote network management platform 320 may be able to discover and manage aspects of the architecture and configuration of managed network 300 and its components. Possibly with the assistance of proxy servers 312, remote network management platform 320 may also be able to discover and manage aspects of public cloud networks 340 that are used by managed network 300.

Firewalls, such as firewall 310, typically deny all communication sessions that are incoming by way of Internet 350, unless such a session was ultimately initiated from behind the firewall (i.e., from a device on managed network 300) or the firewall has been explicitly configured to support the session. By placing proxy servers 312 behind firewall 310 (e.g., within managed network 300 and protected by firewall 310), proxy servers 312 may be able to initiate these communication sessions through firewall 310. Thus, firewall 310 might not have to be specifically configured to support incoming sessions from remote network management platform 320, thereby avoiding potential security risks to managed network 300.

In some cases, managed network 300 may consist of a few devices and a small number of networks. In other deployments, managed network 300 may span multiple physical locations and include hundreds of networks and hundreds of thousands of devices. Thus, the architecture depicted in FIG. 3 is capable of scaling up or down by orders of magnitude.

Furthermore, depending on the size, architecture, and connectivity of managed network 300, a varying number of proxy servers 312 may be deployed therein. For example, each one of proxy servers 312 may be responsible for communicating with remote network management platform 320 regarding a portion of managed network 300. Alternatively or additionally, sets of two or more proxy servers may be assigned to such a portion of managed network 300 for purposes of load balancing, redundancy, and/or high availability.

B. Remote Network Management Platforms

Remote network management platform 320 is a hosted environment that provides aPaaS services to users, particularly to the operator of managed network 300. These services may take the form of web-based portals, for example, using the aforementioned web-based technologies. Thus, a user can securely access remote network management platform 320 from, for example, client devices 302, or potentially from a client device outside of managed network 300. By way of the web-based portals, users may design, test, and deploy applications, generate reports, view analytics, and perform other tasks. Remote network management platform 320 may also be referred to as a multi-application platform.

As shown in FIG. 3, remote network management platform 320 includes four computational instances 322, 324, 326, and 328. Each of these computational instances may represent one or more server nodes operating dedicated copies of the aPaaS software and/or one or more database nodes. The arrangement of server and database nodes on physical server devices and/or virtual machines can be flexible and may vary based on enterprise needs. In combination, these nodes may provide a set of web portals, services, and applications (e.g., a wholly-functioning aPaaS system) available to a particular enterprise. In some cases, a single enterprise may use multiple computational instances.

For example, managed network 300 may be an enterprise customer of remote network management platform 320, and may use computational instances 322, 324, and 326. The reason for providing multiple computational instances to one customer is that the customer may wish to independently develop, test, and deploy its applications and services. Thus, computational instance 322 may be dedicated to application development related to managed network 300, computational instance 324 may be dedicated to testing these applications, and computational instance 326 may be dedicated to the live operation of tested applications and services. A computational instance may also be referred to as a hosted instance, a remote instance, a customer instance, or by some other designation. Any application deployed onto a computational instance may be a scoped application, in that its access to databases within the computational instance can be restricted to certain elements therein (e.g., one or more particular database tables or particular rows within one or more database tables).

For purposes of clarity, the disclosure herein refers to the arrangement of application nodes, database nodes, aPaaS software executing thereon, and underlying hardware as a “computational instance.” Note that users may colloquially refer to the graphical user interfaces provided thereby as “instances.” But unless it is defined otherwise herein, a “computational instance” is a computing system disposed within remote network management platform 320.

The multi-instance architecture of remote network management platform 320 is in contrast to conventional multi-tenant architectures, over which multi-instance architectures exhibit several advantages. In multi-tenant architectures, data from different customers (e.g., enterprises) are comingled in a single database. While these customers' data are separate from one another, the separation is enforced by the software that operates the single database. As a consequence, a security breach in this system may affect all customers' data, creating additional risk, especially for entities subject to governmental, healthcare, and/or financial regulation. Furthermore, any database operations that affect one customer will likely affect all customers sharing that database. Thus, if there is an outage due to hardware or software errors, this outage affects all such customers. Likewise, if the database is to be upgraded to meet the needs of one customer, it will be unavailable to all customers during the upgrade process. Often, such maintenance windows will be long, due to the size of the shared database.

In contrast, the multi-instance architecture provides each customer with its own database in a dedicated computing instance. This prevents comingling of customer data, and allows each instance to be independently managed. For example, when one customer's instance experiences an outage due to errors or an upgrade, other computational instances are not impacted. Maintenance down time is limited because the database only contains one customer's data. Further, the simpler design of the multi-instance architecture allows redundant copies of each customer database and instance to be deployed in a geographically diverse fashion. This facilitates high availability, where the live version of the customer's instance can be moved when faults are detected or maintenance is being performed.

In some embodiments, remote network management platform 320 may include one or more central instances, controlled by the entity that operates this platform. Like a computational instance, a central instance may include some number of application and database nodes disposed upon some number of physical server devices or virtual machines. Such a central instance may serve as a repository for specific configurations of computational instances as well as data that can be shared amongst at least some of the computational instances. For instance, definitions of common security threats that could occur on the computational instances, software packages that are commonly discovered on the computational instances, and/or an application store for applications that can be deployed to the computational instances may reside in a central instance. Computational instances may communicate with central instances by way of well-defined interfaces in order to obtain this data.

In order to support multiple computational instances in an efficient fashion, remote network management platform 320 may implement a plurality of these instances on a single hardware platform. For example, when the aPaaS system is implemented on a server cluster such as server cluster 200, it may operate virtual machines that dedicate varying amounts of computational, storage, and communication resources to instances. But full virtualization of server cluster 200 might not be necessary, and other mechanisms may be used to separate instances. In some examples, each instance may have a dedicated account and one or more dedicated databases on server cluster 200. Alternatively, a computational instance such as computational instance 322 may span multiple physical devices.

In some cases, a single server cluster of remote network management platform 320 may support multiple independent enterprises. Furthermore, as described below, remote network management platform 320 may include multiple server clusters deployed in geographically diverse data centers in order to facilitate load balancing, redundancy, and/or high availability.

C. Public Cloud Networks

Public cloud networks 340 may be remote server devices (e.g., a plurality of server clusters such as server cluster 200) that can be used for outsourced computation, data storage, communication, and service hosting operations. These servers may be virtualized (i.e., the servers may be virtual machines). Examples of public cloud networks 340 may include AMAZON WEB SERVICES® and MICROSOFT® AZURE®. Like remote network management platform 320, multiple server clusters supporting public cloud networks 340 may be deployed at geographically diverse locations for purposes of load balancing, redundancy, and/or high availability.

Managed network 300 may use one or more of public cloud networks 340 to deploy applications and services to its clients and customers. For instance, if managed network 300 provides online music streaming services, public cloud networks 340 may store the music files and provide web interface and streaming capabilities. In this way, the enterprise of managed network 300 does not have to build and maintain its own servers for these operations.

Remote network management platform 320 may include modules that integrate with public cloud networks 340 to expose virtual machines and managed services therein to managed network 300. The modules may allow users to request virtual resources, discover allocated resources, and provide flexible reporting for public cloud networks 340. In order to establish this functionality, a user from managed network 300 might first establish an account with public cloud networks 340, and request a set of associated resources. Then, the user may enter the account information into the appropriate modules of remote network management platform 320. These modules may then automatically discover the manageable resources in the account, and also provide reports related to usage, performance, and billing.

D. Communication Support and Other Operations

Internet 350 may represent a portion of the global Internet. However, Internet 350 may alternatively represent a different type of network, such as a private wide-area or local-area packet-switched network.

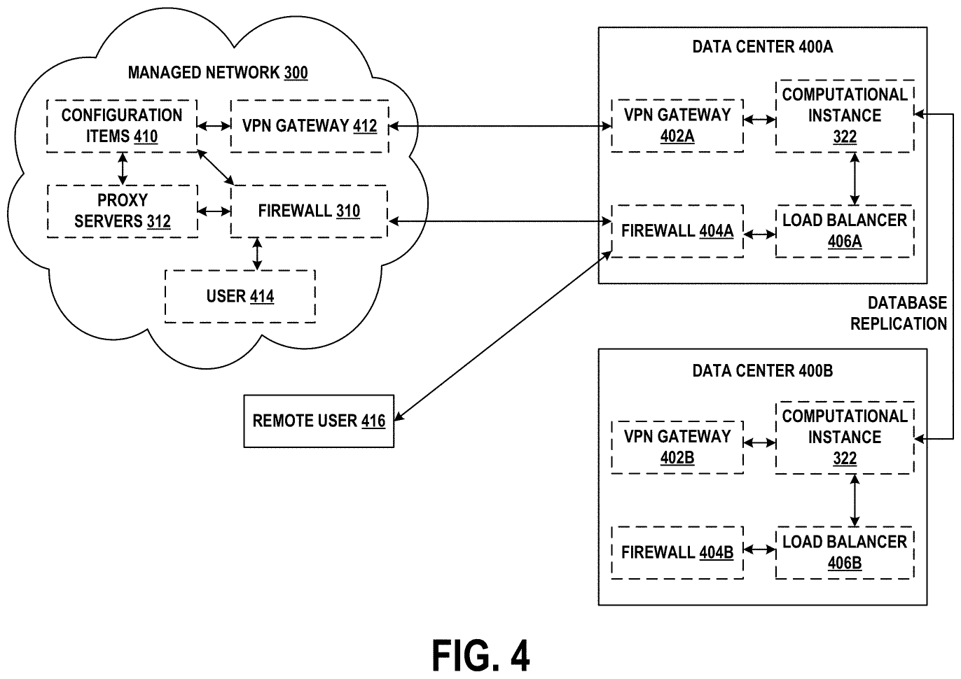

FIG. 4 further illustrates the communication environment between managed network 300 and computational instance 322, and introduces additional features and alternative embodiments. In FIG. 4, computational instance 322 is replicated, in whole or in part, across data centers 400A and 400B. These data centers may be geographically distant from one another, perhaps in different cities or different countries. Each data center includes support equipment that facilitates communication with managed network 300, as well as remote users.

In data center 400A, network traffic to and from external devices flows either through VPN gateway 402A or firewall 404A. VPN gateway 402A may be peered with VPN gateway 412 of managed network 300 by way of a security protocol such as Internet Protocol Security (IPSEC) or Transport Layer Security (TLS). Firewall 404A may be configured to allow access from authorized users, such as user 414 and remote user 416, and to deny access to unauthorized users. By way of firewall 404A, these users may access computational instance 322, and possibly other computational instances. Load balancer 406A may be used to distribute traffic amongst one or more physical or virtual server devices that host computational instance 322. Load balancer 406A may simplify user access by hiding the internal configuration of data center 400A, (e.g., computational instance 322) from client devices. For instance, if computational instance 322 includes multiple physical or virtual computing devices that share access to multiple databases, load balancer 406A may distribute network traffic and processing tasks across these computing devices and databases so that no one computing device or database is significantly busier than the others. In some embodiments, computational instance 322 may include VPN gateway 402A, firewall 404A, and load balancer 406A.

Data center 400B may include its own versions of the components in data center 400A. Thus, VPN gateway 402B, firewall 404B, and load balancer 406B may perform the same or similar operations as VPN gateway 402A, firewall 404A, and load balancer 406A, respectively. Further, by way of real-time or near-real-time database replication and/or other operations, computational instance 322 may exist simultaneously in data centers 400A and 400B.

Data centers 400A and 400B as shown in FIG. 4 may facilitate redundancy and high availability. In the configuration of FIG. 4, data center 400A is active and data center 400B is passive. Thus, data center 400A is serving all traffic to and from managed network 300, while the version of computational instance 322 in data center 400B is being updated in near-real-time. Other configurations, such as one in which both data centers are active, may be supported.

Should data center 400A fail in some fashion or otherwise become unavailable to users, data center 400B can take over as the active data center. For example, domain name system (DNS) servers that associate a domain name of computational instance 322 with one or more Internet Protocol (IP) addresses of data center 400A may re-associate the domain name with one or more IP addresses of data center 400B. After this re-association completes (which may take less than one second or several seconds), users may access computational instance 322 by way of data center 400B.

FIG. 4 also illustrates a possible configuration of managed network 300. As noted above, proxy servers 312 and user 414 may access computational instance 322 through firewall 310. Proxy servers 312 may also access configuration items 410. In FIG. 4, configuration items 410 may refer to any or all of client devices 302, server devices 304, routers 306, and virtual machines 308, any applications or services executing thereon, as well as relationships between devices, applications, and services. Thus, the term “configuration items” may be shorthand for any physical or virtual device, or any application or service remotely discoverable or managed by computational instance 322, or relationships between discovered devices, applications, and services. Configuration items may be represented in a configuration management database (CMDB) of computational instance 322.

As noted above, VPN gateway 412 may provide a dedicated VPN to VPN gateway 402A. Such a VPN may be helpful when there is a significant amount of traffic between managed network 300 and computational instance 322, or security policies otherwise suggest or require use of a VPN between these sites. In some embodiments, any device in managed network 300 and/or computational instance 322 that directly communicates via the VPN is assigned a public IP address. Other devices in managed network 300 and/or computational instance 322 may be assigned private IP addresses (e.g., IP addresses selected from the 10.0.0.0-10.255.255.255 or 192.168.0.0-192.168.255.255 ranges, represented in shorthand as subnets 10.0.0.0/8 and 192.168.0.0/16, respectively).

### IV. EXAMPLE DEVICE, APPLICATION, AND SERVICE DISCOVERY

In order for remote network management platform 320 to administer the devices, applications, and services of managed network 300, remote network management platform 320 may first determine what devices are present in managed network 300, the configurations and operational statuses of these devices, and the applications and services provided by the devices, as well as the relationships between discovered devices, applications, and services. As noted above, each device, application, service, and relationship may be referred to as a configuration item. The process of defining configuration items within managed network 300 is referred to as discovery, and may be facilitated at least in part by proxy servers 312.

For purposes of the embodiments herein, an “application” may refer to one or more processes, threads, programs, client modules, server modules, or any other software that executes on a device or group of devices. A “service” may refer to a high-level capability provided by multiple applications executing on one or more devices working in conjunction with one another. For example, a high-level web service may involve multiple web application server threads executing on one device and accessing information from a database application that executes on another device.

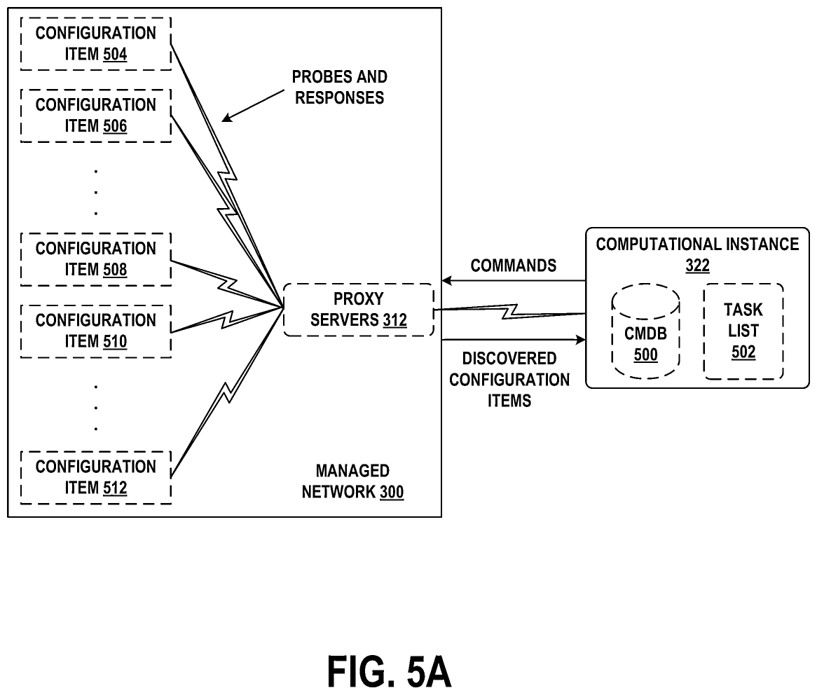

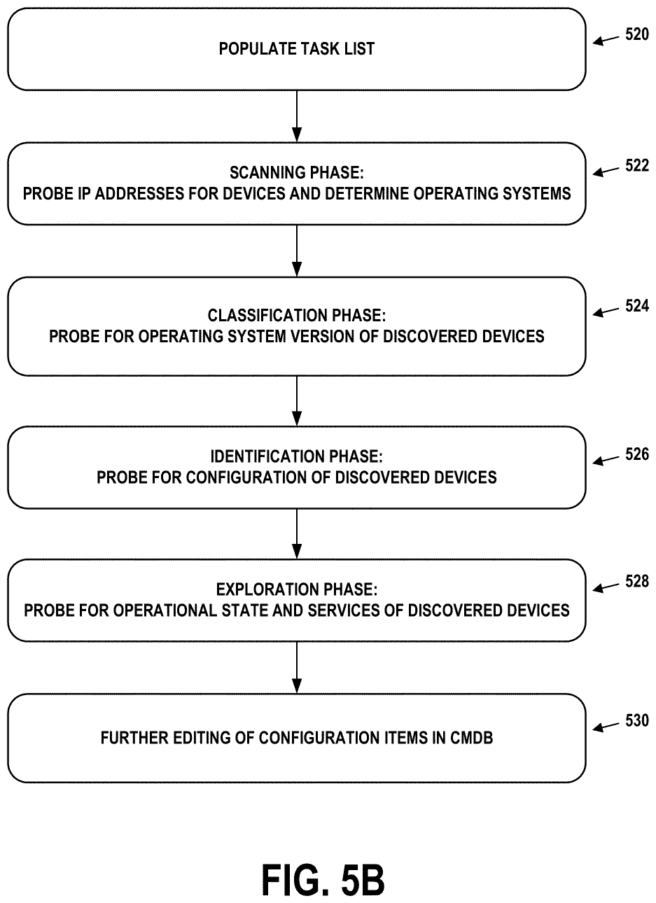

FIG. 5A provides a logical depiction of how configuration items can be discovered, as well as how information related to discovered configuration items can be stored. For sake of simplicity, remote network management platform 320, public cloud networks 340, and Internet 350 are not shown.

In FIG. 5A, CMDB 500 and task list 502 are stored within computational instance 322. Computational instance 322 may transmit discovery commands to proxy servers 312. In response, proxy servers 312 may transmit probes to various devices, applications, and services in managed network 300. These devices, applications, and services may transmit responses to proxy servers 312, and proxy servers 312 may then provide information regarding discovered configuration items to CMDB 500 for storage therein. Configuration items stored in CMDB 500 represent the environment of managed network 300.

Task list 502 represents a list of activities that proxy servers 312 are to perform on behalf of computational instance 322. As discovery takes place, task list 502 is populated. Proxy servers 312 repeatedly query task list 502, obtain the next task therein, and perform this task until task list 502 is empty or another stopping condition has been reached.

To facilitate discovery, proxy servers 312 may be configured with information regarding one or more subnets in managed network 300 that are reachable by way of proxy servers 312. For instance, proxy servers 312 may be given the IP address range 192.168.0/24 as a subnet. Then, computational instance 322 may store this information in CMDB 500 and place tasks in task list 502 for discovery of devices at each of these addresses.

FIG. 5A also depicts devices, applications, and services in managed network 300 as configuration items 504, 506, 508, 510, and 512. As noted above, these configuration items represent a set of physical and/or virtual devices (e.g., client devices, server devices, routers, or virtual machines), applications executing thereon (e.g., web servers, email servers, databases, or storage arrays), relationships therebetween, as well as services that involve multiple individual configuration items.

Placing the tasks in task list 502 may trigger or otherwise cause proxy servers 312 to begin discovery. Alternatively or additionally, discovery may be manually triggered or automatically triggered based on triggering events (e.g., discovery may automatically begin once per day at a particular time).

In general, discovery may proceed in four logical phases: scanning, classification, identification, and exploration. Each phase of discovery involves various types of probe messages being transmitted by proxy servers 312 to one or more devices in managed network 300. The responses to these probes may be received and processed by proxy servers 312, and representations thereof may be transmitted to CMDB 500. Thus, each phase can result in more configuration items being discovered and stored in CMDB 500.

In the scanning phase, proxy servers 312 may probe each IP address in the specified range of IP addresses for open Transmission Control Protocol (TCP) and/or User Datagram Protocol (UDP) ports to determine the general type of device. The presence of such open ports at an IP address may indicate that a particular application is operating on the device that is assigned the IP address, which in turn may identify the operating system used by the device. For example, if TCP port 135 is open, then the device is likely executing a WINDOWS® operating system. Similarly, if TCP port 22 is open, then the device is likely executing a UNIX® operating system, such as LINUX®. If UDP port 161 is open, then the device may be able to be further identified through the Simple Network Management Protocol (SNMP). Other possibilities exist. Once the presence of a device at a particular IP address and its open ports have been discovered, these configuration items are saved in CMDB 500.

In the classification phase, proxy servers 312 may further probe each discovered device to determine the version of its operating system. The probes used for a particular device are based on information gathered about the devices during the scanning phase. For example, if a device is found with TCP port 22 open, a set of UNIX®-specific probes may be used. Likewise, if a device is found with TCP port 135 open, a set of WINDOWS®-specific probes may be used. For either case, an appropriate set of tasks may be placed in task list 502 for proxy servers 312 to carry out. These tasks may result in proxy servers 312 logging on, or otherwise accessing information from the particular device. For instance, if TCP port 22 is open, proxy servers 312 may be instructed to initiate a Secure Shell (SSH) connection to the particular device and obtain information about the operating system thereon from particular locations in the file system. Based on this information, the operating system may be determined. As an example, a UNIX® device with TCP port 22 open may be classified as AIX®, HPUX, LINUX®, MACOS®, or SOLARIS®. This classification information may be stored as one or more configuration items in CMDB 500.

In the identification phase, proxy servers 312 may determine specific details about a classified device. The probes used during this phase may be based on information gathered about the particular devices during the classification phase. For example, if a device was classified as LINUX®, a set of LINUX®-specific probes may be used. Likewise, if a device was classified as WINDOWS® 2012, as a set of WINDOWS®-2012-specific probes may be used. As was the case for the classification phase, an appropriate set of tasks may be placed in task list 502 for proxy servers 312 to carry out. These tasks may result in proxy servers 312 reading information from the particular device, such as basic input/output system (BIOS) information, serial numbers, network interface information, media access control address(es) assigned to these network interface(s), IP address(es) used by the particular device and so on. This identification information may be stored as one or more configuration items in CMDB 500.

In the exploration phase, proxy servers 312 may determine further details about the operational state of a classified device. The probes used during this phase may be based on information gathered about the particular devices during the classification phase and/or the identification phase. Again, an appropriate set of tasks may be placed in task list 502 for proxy servers 312 to carry out. These tasks may result in proxy servers 312 reading additional information from the particular device, such as processor information, memory information, lists of running processes (applications), and so on. Once more, the discovered information may be stored as one or more configuration items in CMDB 500.

Running discovery on a network device, such as a router, may utilize SNMP. Instead of or in addition to determining a list of running processes or other application-related information, discovery may determine additional subnets known to the router and the operational state of the router's network interfaces (e.g., active, inactive, queue length, number of packets dropped, etc.). The IP addresses of the additional subnets may be candidates for further discovery procedures. Thus, discovery may progress iteratively or recursively.

Once discovery completes, a snapshot representation of each discovered device, application, and service is available in CMDB 500. For example, after discovery, operating system version, hardware configuration, and network configuration details for client devices, server devices, and routers in managed network 300, as well as applications executing thereon, may be stored. This collected information may be presented to a user in various ways to allow the user to view the hardware composition and operational status of devices, as well as the characteristics of services that span multiple devices and applications.

Furthermore, CMDB 500 may include entries regarding dependencies and relationships between configuration items. More specifically, an application that is executing on a particular server device, as well as the services that rely on this application, may be represented as such in CMDB 500. For example, suppose that a database application is executing on a server device, and that this database application is used by a new employee onboarding service as well as a payroll service. Thus, if the server device is taken out of operation for maintenance, it is clear that the employee onboarding service and payroll service will be impacted. Likewise, the dependencies and relationships between configuration items may be able to represent the services impacted when a particular router fails.

In general, dependencies and relationships between configuration items may be displayed on a web-based interface and represented in a hierarchical fashion. Thus, adding, changing, or removing such dependencies and relationships may be accomplished by way of this interface.

Furthermore, users from managed network 300 may develop workflows that allow certain coordinated activities to take place across multiple discovered devices. For instance, an IT workflow might allow the user to change the common administrator password to all discovered LINUX® devices in a single operation.

In order for discovery to take place in the manner described above, proxy servers 312, CMDB 500, and/or one or more credential stores may be configured with credentials for one or more of the devices to be discovered. Credentials may include any type of information needed in order to access the devices. These may include userid/password pairs, certificates, and so on. In some embodiments, these credentials may be stored in encrypted fields of CMDB 500. Proxy servers 312 may contain the decryption key for the credentials so that proxy servers 312 can use these credentials to log on to or otherwise access devices being discovered.

The discovery process is depicted as a flow chart in FIG. 5B. At block 520, the task list in the computational instance is populated, for instance, with a range of IP addresses. At block 522, the scanning phase takes place. Thus, the proxy servers probe the IP addresses for devices using these IP addresses, and attempt to determine the operating systems that are executing on these devices. At block 524, the classification phase takes place. The proxy servers attempt to determine the operating system version of the discovered devices. At block 526, the identification phase takes place. The proxy servers attempt to determine the hardware and/or software configuration of the discovered devices. At block 528, the exploration phase takes place. The proxy servers attempt to determine the operational state and applications executing on the discovered devices. At block 530, further editing of the configuration items representing the discovered devices and applications may take place. This editing may be automated and/or manual in nature.

The blocks represented in FIG. 5B are examples. Discovery may be a highly configurable procedure that can have more or fewer phases, and the operations of each phase may vary. In some cases, one or more phases may be customized, or may otherwise deviate from the exemplary descriptions above.

In this manner, a remote network management platform may discover and inventory the hardware, software, and services deployed on and provided by the managed network. As noted above, this data may be stored in a CMDB of the associated computational instance as configuration items. For example, individual hardware components (e.g., computing devices, virtual servers, databases, routers, etc.) may be represented as hardware configuration items, while the applications installed and/or executing thereon may be represented as software configuration items.

The relationship between a software configuration item installed or executing on a hardware configuration item may take various forms, such as “is hosted on”, “runs on”, or “depends on”. Thus, a database application installed on a server device may have the relationship “is hosted on” with the server device to indicate that the database application is hosted on the server device. In some embodiments, the server device may have a reciprocal relationship of “used by” with the database application to indicate that the server device is used by the database application. These relationships may be automatically found using the discovery procedures described above, though it is possible to manually set relationships as well.

The relationship between a service and one or more software configuration items may also take various forms. As an example, a web service may include a web server software configuration item and a database application software configuration item, each installed on different hardware configuration items. The web service may have a “depends on” relationship with both of these software configuration items, while the software configuration items have a “used by” reciprocal relationship with the web service. Services might not be able to be fully determined by discovery procedures, and instead may rely on service mapping (e.g., probing configuration files and/or carrying out network traffic analysis to determine service level relationships between configuration items) and possibly some extent of manual configuration.

Regardless of how relationship information is obtained, it can be valuable for the operation of a managed network. Notably, IT personnel can quickly determine where certain software applications are deployed, and what configuration items make up a service. This allows for rapid pinpointing of root causes of service outages or degradation. For example, if two different services are suffering from slow response times, the CMDB can be queried (perhaps among other activities) to determine that the root cause is a database application that is used by both services having high processor utilization. Thus, IT personnel can address the database application rather than waste time considering the health and performance of other configuration items that make up the services.

### V. GRAPHICAL USER INTERFACE SUPPORT FOR DISPLAYING RELATED INFORMATION

Tasks, often in the form of workflows or playbooks, have become an important part of enterprise computing. For instance, a workflow may define a sequence, ordering, or directed graph of subtasks that are to be carried out by one or more computers or individuals in order to accomplish an overarching task.

As a simple example, a case workflow can be used to address a problem or request raised by a user. Each case may represent a task assigned to an agent, and may consist of a linear ordering of subtasks that the agent is to perform. In order, these subtasks may be for the agent to: (i) investigate the issue raised, (ii) review details related to the user and/or the services to which the user subscribes, (iii) work on resolving the case, and (iv) close the case when it is resolved.

Many other possible workflows exist with more or fewer subtasks. In some cases, “playbooks” may be defined that guide the agent through a canonical sequence of subtasks that have been established to address certain types of common issues. Some subtasks of a workflow could be automated and thus performed entirely by computer, while others could involve only human interaction or a combination of human and computer interaction.

Unless context suggests otherwise, the terms “task”, “workflow”, and “playbook” shall be used interchangeably herein. Nonetheless, other terms of art could be used to refer to these items.

Given that execution of workflows can make up a significant portion of the utilization of a remote network management platform, any effort to reduce the impact that workflow execution has on the computing resources of the platform would be welcome. As will be described below, the nature of current graphical user interface designs that support workflows, as well as their underlying database schema, are such that agents have to switch back and forth between web pages or tabs on a web page in order to obtain the information needed to carry out a subtask. Each time the user switches, a further query to a data source (e.g., a database) may be made so that the graphical user interface representing the workflow can be updated. This results in unnecessary additional load being introduced to the remote network management platform.

The embodiments herein provide an improved graphical user interface design and layout, as well as improved database schema techniques. These improvements result in the majority, if not all, relevant information for each subtask being displayed on a single web page. Further, these embodiments are significantly more flexible than previous systems, allowing simplified configuration of displays involving data to be retrieved from data sources beyond just databases. Additionally, while it is assumed for sake of simplicity that the graphical user interfaces herein are implemented as web pages, other implementations may be possible, including other types of web elements, web components, or visual features within a different user interface framework.

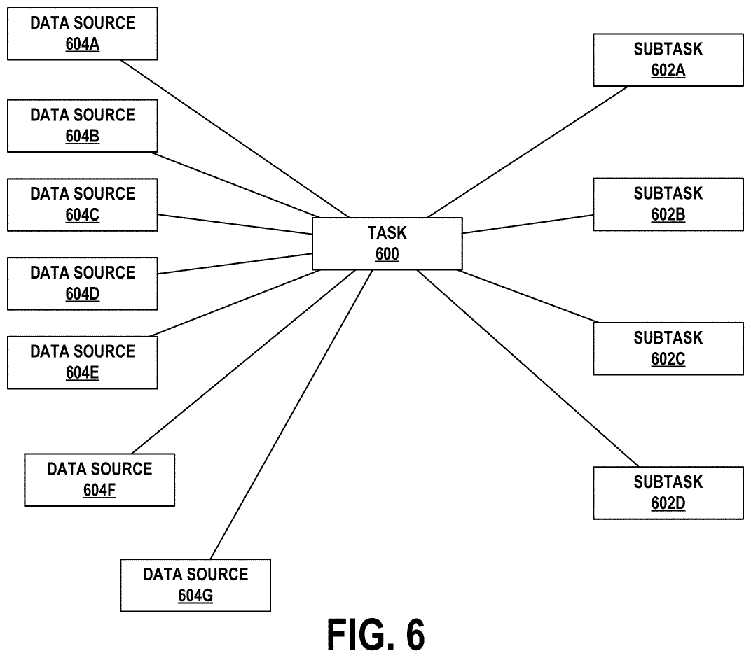

FIG. 6 depicts a logical hierarchy for a task, its subtasks, and associated data sources. Here, task 600 may represent a workflow or playbook, and may be comprised of subtasks 602A, 602B, 602C, and 602D. Further, task 600 may define an ordering in which subtasks 602A, 602B, 602C, and 602D are to be carried out. Such an ordering could be linear, tree-based, and may contain loops and/or repeated subtasks.

For example, task 600 may specify that the workflow or playbook starts with subtask 602A, then proceeds to subtasks 602B, 602C, and 602D in that order. Alternatively, task 600 may specify that the workflow or playbook starts with subtask 602A, and then proceeds to subtask 602B followed by subtask 602C. From subtask 602C, the workflow or playbook may proceed back to subtask 602B or on to subtask 602D. Other possibilities exist.

Additionally, task 600 could be associated with one or more data sources. As shown, data sources 604A, 604B, 604C, 604D, 604E, 604F, and 604G are associated with task 600. These data sources may be one or more tables of a database (e.g., a CMDB or some other database of the remote network management platform), an API of a remote service (e.g., a representational state transfer (REST) API of a third-party service with information relevant to the task), a local file (e.g., a file stored on by the remote network management platform), a machine learning model (e.g., a similarity or clustering model trained based on data related to the task), or some other type of data source. Data from these data sources may be incorporated into web pages of the workflow that are displayed to the agent generally and/or during various subtasks.

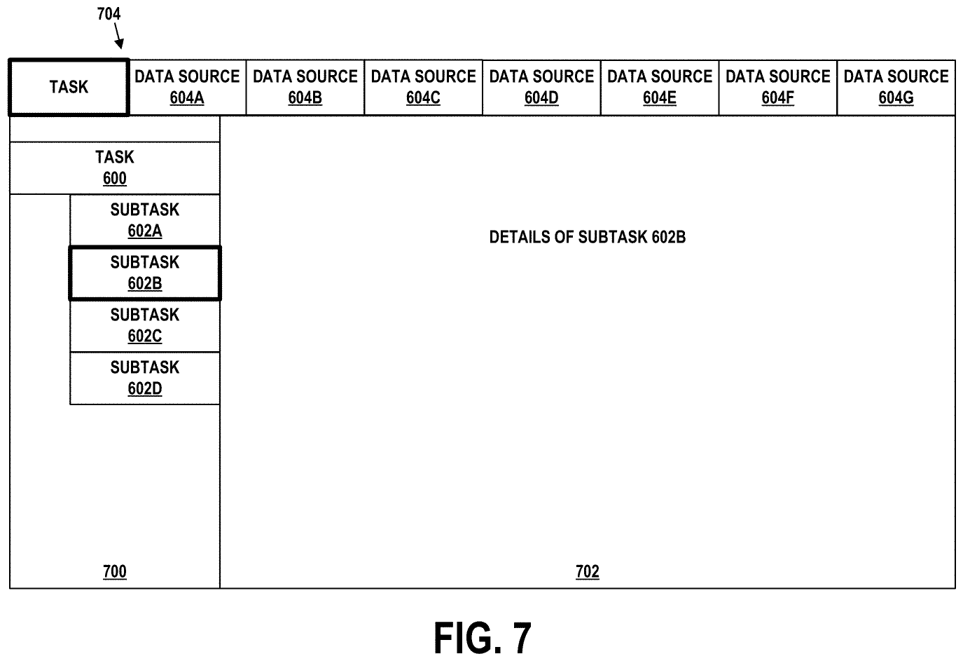

FIG. 7 depicts an example tabbed graphical user interface layout based on the logical hierarchy of FIG. 6. Particularly, this graphical user interface may be a web page that consists of menu pane 700, subtask pane 702, and tabs 704. Each of tabs 704 may be selected, clicked on, or otherwise actuated to change or control what is displayed in menu pane 700 and subtask pane 702 (herein the term “selected” or variations thereof may refer any mechanism for actuating a graphical user interface component). Typically, only one tab may be selected at any point in time. Likewise, designated items in menu pane 700 may be selected to further change or control what is displayed in subtask pane 702.

As shown, the task tab of tabs 704 is selected (indicated by thicker lines). This causes display of task 600 and its subtasks in menu pane 700. Of the subtasks, subtask 602B is selected (indicated by thicker lines). This causes display of details of subtask 602B in subtask pane 702. These details may include, for example, text and image displays, text input boxes and/or drop-drop menus that the agent is expected to use when carrying out subtask 602B.

When the agent selects a different tab, such as the tab for data source 604D as an example, menu pane 700 and subtask pane 702 be reloaded with information related to this data source. Thus, each time a tab is selected, the associated data source may be queried one or more times to obtain this information, and then the information is formulated into a web page for display to the agent.

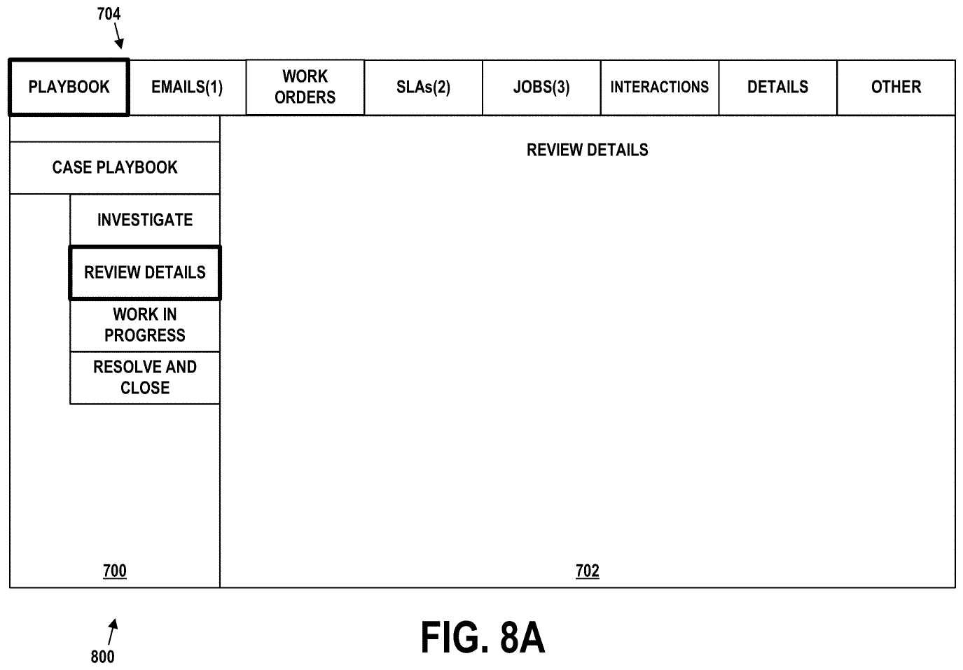

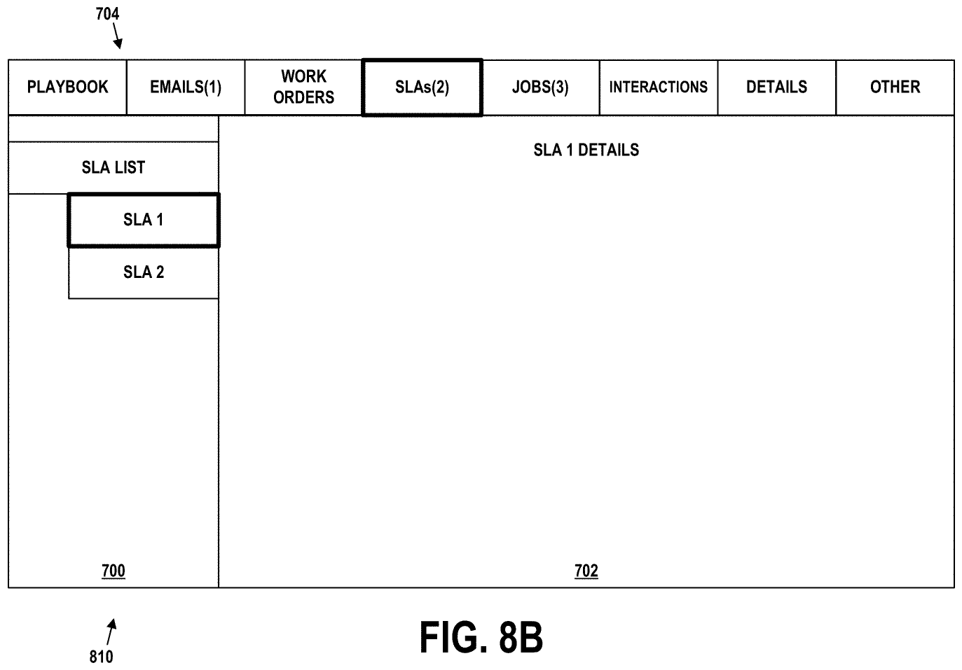

FIGS. 8A and 8B provide a more concrete example of the operation of such a graphical user interface, and its corresponding limitations. Graphical user interface 800 in FIG. 8A and graphical user interface 810 in FIG. 8B depict a version of a possible web page implementation of the graphical user interface layout depicted in FIG. 7.

Particularly, FIGS. 8A and 8B show specific data sources for tabs 704. The tabs shown in FIGS. 8A and 8B has a one-to-one mapping with the tabs shown in FIG. 7. Thus, the playbook tab maps to the task tab, the emails tab maps to the data source 604A tab, the work orders tab maps to the data source 604B tab, the SLAs tab maps to the data source 604C tab, the jobs tab maps to the data source 604D tab, the interactions tab maps to the data source 604E tab, the details tab maps to the data source 604F tab, and the other tab maps to the data source 604G tab.

The “playbook” tab of tabs 704 is shown as having been selected in FIG. 8A. This playbook consists of subtasks of “investigate”, “review details”, “work in progress”, and “resolve and close”, which are displayed in a selectable menu in menu pane 700. Further, the “review details” subtask is also shown as having been selected in menu pane 700. Thus, subtask pane 702 displays information detailing this subtask (these details are not shown in FIG. 8A for purposes of simplicity).

Other tabs of tabs 704 refer to data sources that contain information that is deemed to be relevant to the current task. For example, there are two related service level agreements (SLAs), three jobs, and one email, as indicated in tabs 704. During the course of the agent carrying out the review details subtask, some of this related information may be required by or at least helpful to the agent. However, the current graphical user interface layout and underlying logical hierarchy of information (i.e., that of FIG. 6) does not indicate which tabs contain information that is relevant to each specific subtask.

For example, information from the data source associated with the SLAs tab may be relevant to the “review details” subtask, while information from the jobs and email data sources might not be relevant. Likewise, information from the data source associated with the emails and work orders tabs may be relevant to the “investigate” subtask, while information from the SLAs and jobs data sources might not be relevant.

However, the arrangement of information in the logical hierarchy does not indicate the relevance of information in certain data sources to specific subtasks. As a consequence, the graphical user interface may provide information from the data sources, respectively in tabs 704, that is relevant to the task in general. Thus, in order to access information that is relevant to a specific subtask, the agent may have to switch between multiple tabs while carrying out the subtask.

To that point, FIG. 8B depicts the web page implementation from FIG. 8A as graphical user interface 810. In FIG. 8B, the SLAs tab of tabs 704 has been selected. This selection caused menu pane 700 to display an SLA list consisting of SLA 1 and SLA 2 (the two SLAs indicated in the SLAs tab). Of these, SLA 1 has been selected, which caused display of information related to SLA 1 in subtask pane 702. While not shown in FIG. 8B for purposes of simplicity, this information may include static data as well as data retrieved from a data source.

Notably, the information related to the “review details” subtask is no longer shown when the SLA tab is selected. This may cause the agent to lose the context of the subtask, resulting in the agent then selecting the playbook tab once again and navigating to the “review details” subtask. In some situations, the agent may switch back and forth between the SLAs and playbook tabs several times in order to double check information respectively appearing on these tabs. In other situations, the agent may switch between three or four tabs some number of times in order to gather all of the desired information.

A consequence of this behavior is that each time the agent switches to a new tab, a number of queries to the associated data sources may be made. These queries each utilize computational resources (e.g., processor, memory, and/or network capacity) of the data source. Additionally, computational resources of the remote network management platform may be used to formulate the results of the queries into web page data and provide this web page data to the agent's client device. Thus, when this switching can be prevented or discouraged, there will be a performance benefit for the data sources as well as the remote network management platform.

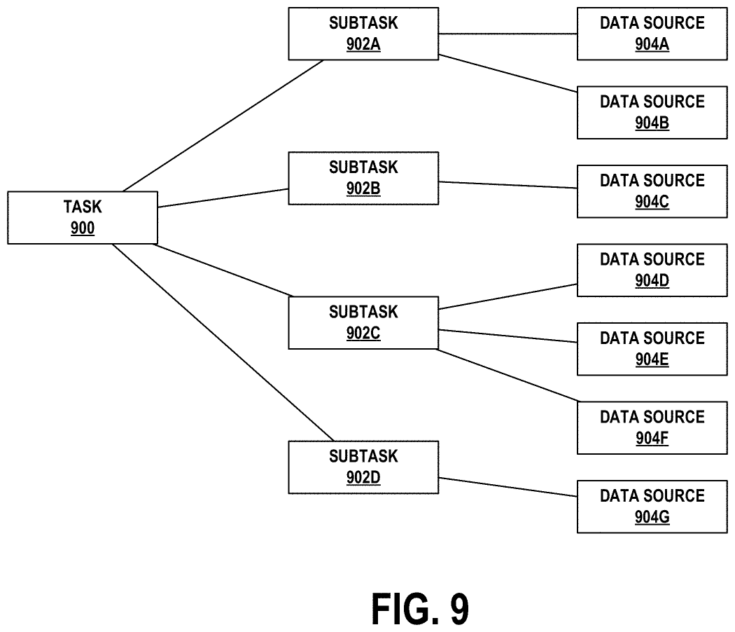

In order to reduce computational resource utilization, an improved logical hierarchy for tasks, subtasks, and their related information is shown in FIG. 9. Analogous to task 600, task 900 may represent a workflow or playbook that is comprised of subtasks 902A, 902B, 902C, and 902D. Further, task 900 may define an ordering in which subtasks 902A, 902B, 902C, and 902D are to be carried out.

Unlike the logical hierarchy of FIG. 6 that associates data sources with the task in general, each subtask is associated with one or more data sources in FIG. 9. Data from these data sources may be displayed or used as the basis of information displayed to the agent during the associated subtasks.

As shown, subtask 902A is associated with data sources 904A and 904B, subtask 902B is associated with data source 904C, subtask 902C is associated with data sources 904D, 904E, and 904F, and subtask 902D is associated with data source 904G. As noted, these data sources may be one or more tables of a database, an API of a remote service, a local file, a machine learning model, or some other type of data source.

Some data sources could be used by multiple subtasks. For instance, data sources 904C and 904E may be the same data source. Further, each subtask may define or otherwise be associated with one or more scripts that are programmed to retrieve specific information from the associated data source(s) and display this information in a particular fashion on a graphical user interface.

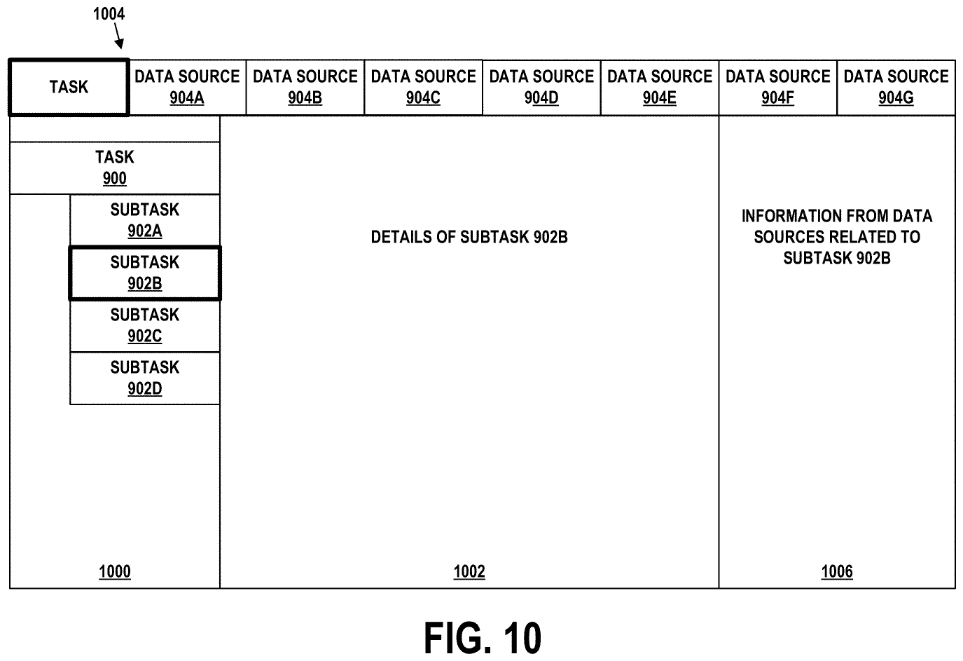

FIG. 10 depicts an example tabbed graphical user interface layout based on the logical hierarchy of FIG. 9. Particularly, this graphical user interface may be a web page that consists of menu pane 1000, subtask pane 1002, tabs 1004, and related information pane 1006. Each of tabs 1004 may be selected to change or control what is displayed in menu pane 1000, subtask pane 1002, and/or related information pane 1006. Likewise, designated items in menu pane 1000 may be selected to further change or control what is displayed in subtask pane 1002 and/or related information pane 1006.

As shown, the task tab of tabs 1004 is selected (indicated by thicker lines). This causes display of task 900 and its subtasks in menu pane 1000. Of the subtasks, subtask 902B is selected (indicated by thicker lines). This causes display of details of subtask 902B in subtask pane 1002. These details may include, for example, text and image displays, text input boxes and/or drop-drop menus that the agent is expected to use when carrying out subtask 902B. Selection of subtask 902B also causes retrieval of information related to subtask 902B from its associated data source(s), as well as display of this information in related information pane 1006. Notably, the logical hierarchy of FIG. 9 indicates that data source 904C stores information relevant to subtask 902B. Therefore, related information pane 1006 may display information retrieved from data source 904C.

Advantageously, displaying this related information on the same web page as the details of subtask 902B can eliminate the need for the agent to switch back and forth between displaying the task tab and the tab for data source 904C. This, in turn, results in a reduced load on the computational resources of data source 904C and the remote network management platform.

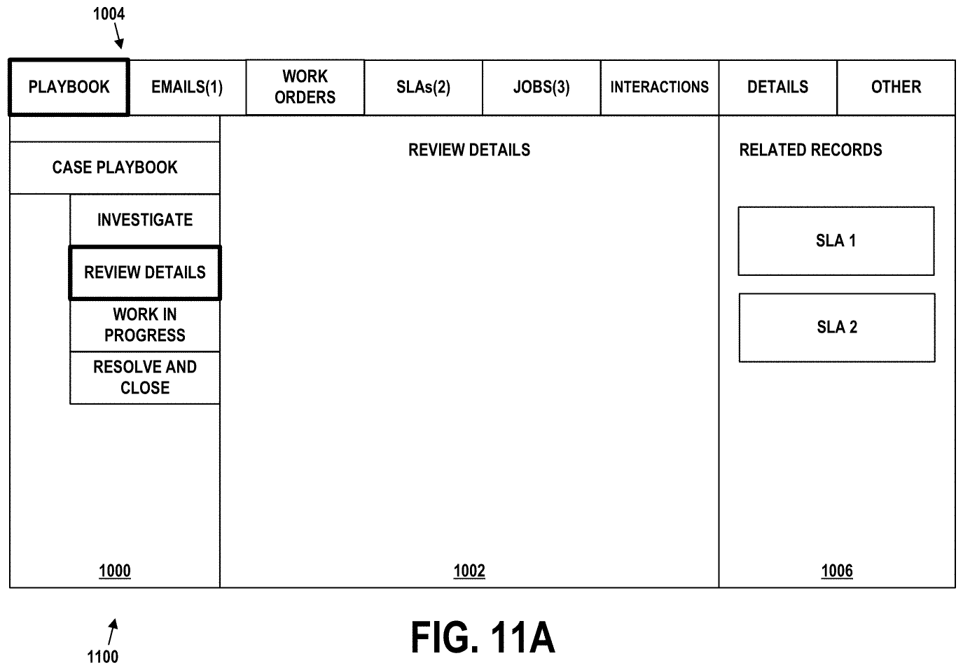

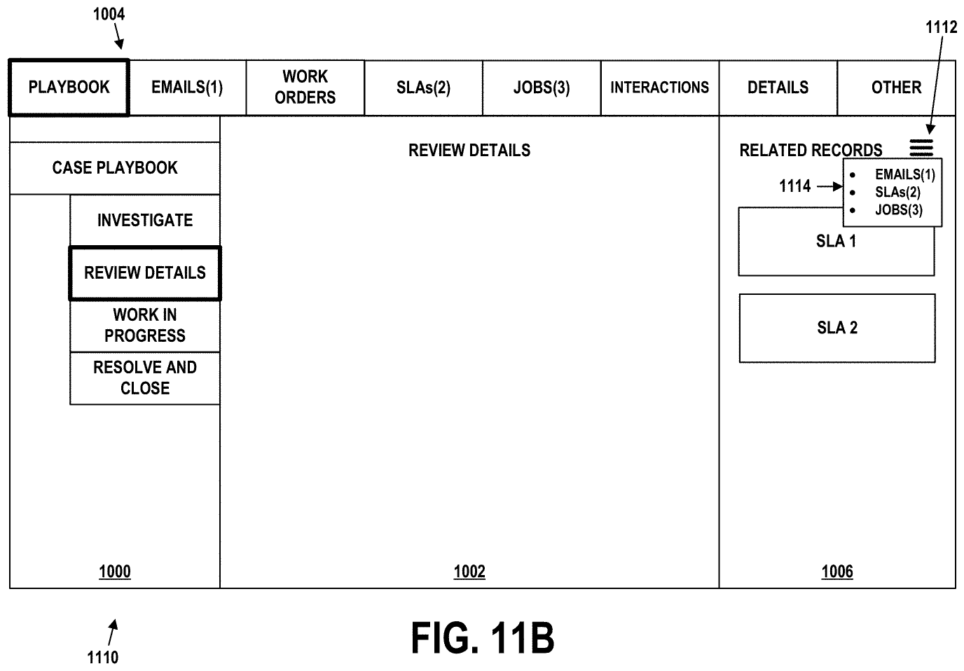

FIGS. 11A and 11B provide a more concrete example of the operation of such a graphical user interface, and its corresponding limitations. Particularly, 11A and 11B show specific data sources for tabs 1004, where appropriate. The tabs shown in FIGS. 11A and 11B have a one-to-one mapping with the tabs shown in FIG. 10. Thus, the playbook tab maps to the task tab, the emails tab maps to the data source 904A tab, the work orders tab maps to the data source 904B tab, the SLAs tab maps to the data source 904C tab, the jobs tab maps to the data source 904D tab, the interactions tab maps to the data source 904E tab, the details tab maps to the data source 904F tab, and the other tab maps to the data source 904G tab.

Graphical user interface 1100 in FIG. 11A and graphical user interface 1110 in FIG. 11B depict a version of a possible web page implementation of the graphical user interface layout depicted in FIG. 10. Particularly, graphical user interface 1100 shows the “playbook” tab of tabs 1004 as having been selected. As shown in menu pane 1000 of FIG. 11A, this playbook consists of subtasks of “investigate”, “review details”, “work in progress”, and “resolve and close”. Further, the “review details” subtask is also shown as having been selected in menu pane 1000. Thus, subtask pane 1002 displays the details of this subtask.

Notably, related information pane 1006 displays information from SLA 1 and SLA 2 of the SLAs. This information is displayed because the logical hierarchy of FIG. 9 indicates that subtask 902B (here, implemented as the “review details” subtask) is related to data source 904C (here, implemented as the SLAs data source). In a similar fashion, when the “investigate” subtask is selected in menu pane 1000, related information pane 1006 may display information from emails and work orders. This information would be displayed because the logical hierarchy of FIG. 9 indicates that subtask 902A (here, implemented as the “investigate” subtask) is related to data sources 904A (here, implemented as the emails data source) and 904B (here, implemented as the work orders data source).

The information displayed in related information pane 1006 is formatted as cards (e.g., rectangular objects, one per unit of information), but other graphical user interface elements could be used. For example, this information could appear in a list or a menu as just two possibilities.

This arrangement of related information provides the agent with what he or she is most likely to need during each subtask, all on one web page. Further, the exact format and presentation of the related information can be configured by way of Boolean logic, arithmetic operations, and/or script logic. This flexibility enables the customizing of how and what information is displayed in related information pane 1006. Moreover, as discussed above, the providing of the information in a single web page results in less overall resource utilization on the remote network management platform and related computing devices.

As a further example of the flexibility enabled by this approach, FIG. 11B depicts graphical user interface 1110. The layout of graphical user interface 1110 is similar to that of graphical user interface 1100 with the addition of menu icon 1112 and menu 1114. Selection of menu icon 1112 may cause menu 1114 to be displayed in a drop-down fashion.

Menu 1114 includes a list of related information for some or all of the subtasks. Accordingly, menu 1114 displays entries for emails, SLAs, and jobs, which are the three data sources with information related to the subtasks shown in menu pane 1000. Each of these entries may be selectable, and when selected cause the corresponding information to be displayed in related information pane 1006. For example, if the emails entry is selected, related information pane 1006 may be modified to display emails related to the case being handled by the agent. In some situations, entries in the menu may be related to information that can be obtained from a data source that is not shown in any of tabs 1004.

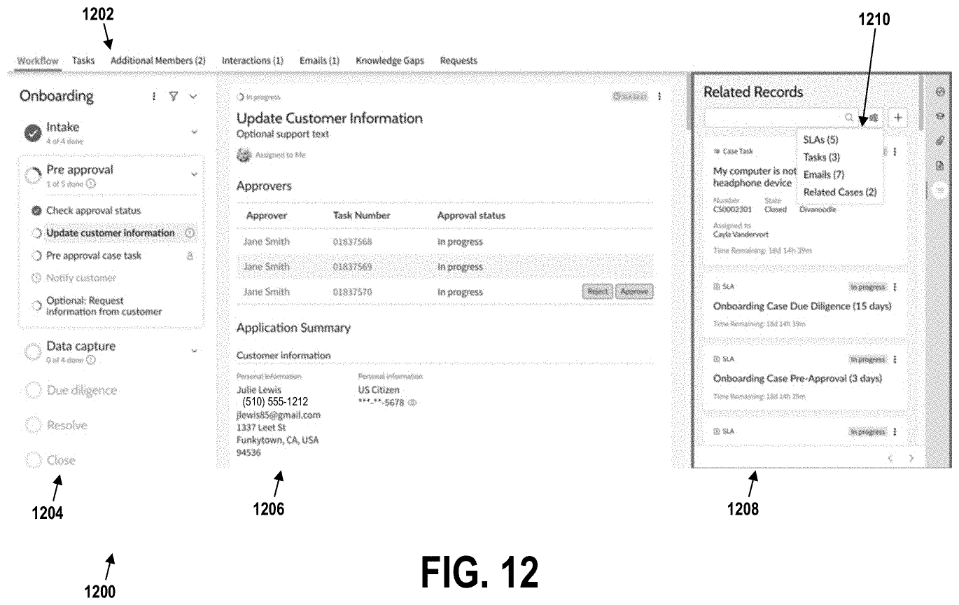

A further example of the improved single-web page layout is shown in FIG. 12. To that end, graphical user interface 1200 is an illustrative mock-up of the web page for a different workflow. This web page includes tabs 1202, menu pane 1204, subtask pane 1206, and related information pane 1208. Related information pane 1208 shows the display of menu 1210. Unless indicated otherwise, the components of graphical user interface 1200 are analogous to those of graphical user interface 1110.

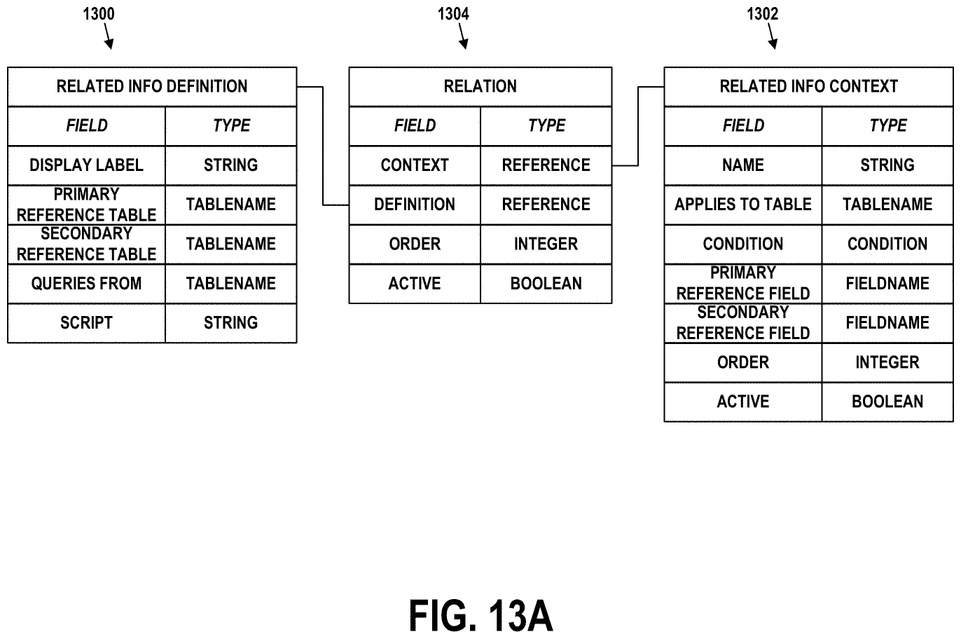

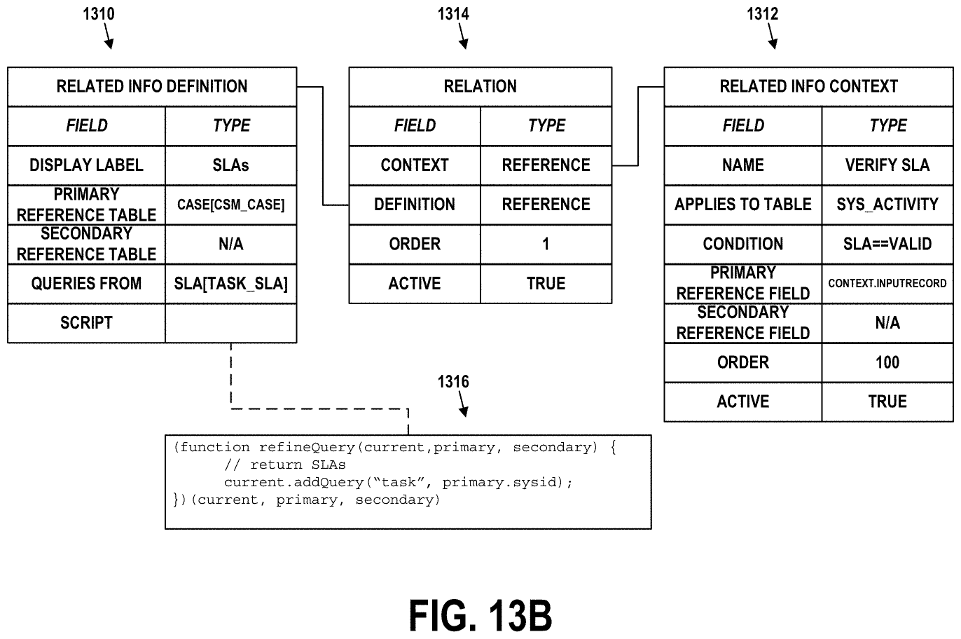

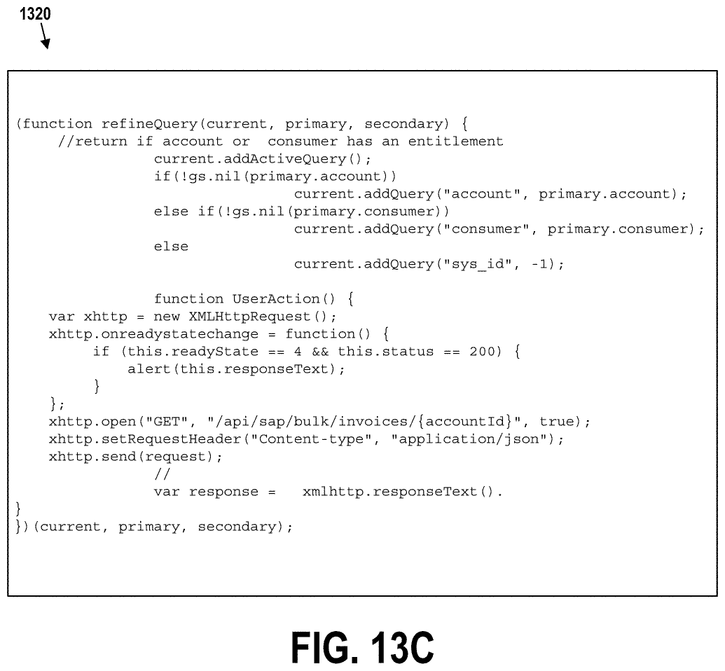

In order to facilitate these features, a new database schema has been developed. This schema can be implemented as part of one or more databases used by the remote network management platform. Thus, the tables of this schema are new tables that can be added to an existing schema. An example implementation of such a schema is shown in FIG. 13A

Table 1300 is a related information definition table that defines the context of a workflow (e.g., the subtask being performed) and provides a reference to a data source as well as an optional definition of a script to execute on the data obtained from the data source. Table 1302 is a related information context table that defines operations that are to take place on the related information obtained from the data source. For example, the related information may be temporarily stored in yet another database table (not shown) and conditional operations may be applied to selective fields of this table. This allows the related information to be filtered and formatted prior to display on a graphical user interface. Table 1304 is a relationship table that matches entries from table 1300 with those of 1302.

The fields of table 1300 can be described as follows. The display label field is a string that is displayed along with the related information. The primary reference table field identifies the table of the task that is being carried out by the agent (e.g., the table that was queried to obtain information about the task in general). The secondary reference table field identifies another table of this task in the case that information about the task is distributed across more than one table. The queries from field is a reference to the table that stores the related information. The script field specifies an optional script to execute on the related information. Such a script may transform the related information, or provide it to a third-party API or a machine learning model, for example. Thus, the combination of the queries from field and the script field allow various types of data sources to be specified.

The fields of table 1302 can be described as follows. The name field specifies a name for the related information. The applies to field specifies the table in which the related information is temporarily storage after it is retrieved. The condition field specifies a Boolean and/or arithmetic expression to apply to the related information, which may serve to filter this information. The primary reference field specifies the field of the table in the applies to field on to which the condition is applied. The secondary reference field specifies another field of the same table in case the condition requires two operands. The order field is used to determine the ordering of operations when more than one entry from table 1302 is to be applied to the related information. The active field indicates when the entry is active.

The fields of table 1304 can be described as follows. The context field refers to an entry in table 1302. The definition field refers to an entry in table 1300. This structure allows m-to-n relationships to be formed between entries in these two tables. The order field is used to determine the ordering of operations when more than one entry from table 1304 is to be applied. The active field indicates when the entry is active.

FIG. 13B provides a more concrete example of how these tables might be populated. Table 1310 contains the related information definitions, table 1312 contains the related information context, and table 1314 matches entries from table 1310 with those of 1312.

In table 1310, the display label field specifies that the string “SLAs” is to be displayed. The primary reference table field identifies the table case[csm_case]. The secondary reference table field is not used. The queries from field identifies the table sla[task_sla]. The script field specifies script 1316 that is applied to the related information.

In table 1312, the name field specifies the string “Verify SLA”. The applies to field specifies the table sys_activity. The condition field filters the related information to include only items with a valid SLA. The primary reference field specifies the field context.inputrecord. The secondary reference field is not used. The order field is set to 100. The active field indicates that the entry is active.

In table 1314, the context field refers to an entry in table 1312. The definition field refers to an entry in table 1310. The order field is set to 1. The active field indicates that the entry is active.

In some embodiments, scripts that are more complex can be used to reference other data sources. FIG. 13C provides an example of such a script. Particularly, script 1320 uses an XMLHttpRequest object to send and receive a request from a remote REST API. Facilitating scripts in this fashion allows for arbitrary logic to be applied to related information and the results thereof to be displayed in a related information pane of a graphical user interface.

### VI. EXAMPLE OPERATIONS

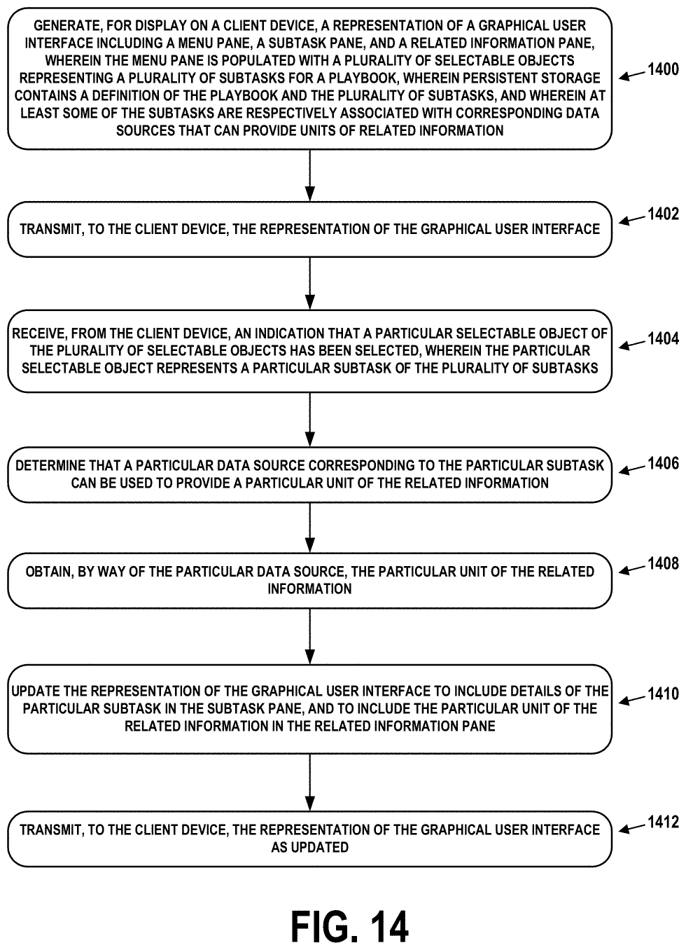

FIG. 14 is a flow chart illustrating an example embodiment. The process illustrated by FIG. 14 may be carried out by a computing device, such as computing device 100, and/or a cluster of computing devices, such as server cluster 200. However, the process can be carried out by other types of devices or device subsystems. For example, the process could be carried out by a computational instance of a remote network management platform or a portable computer, such as a laptop or a tablet device.

The embodiments of FIG. 14 may be simplified by the removal of any one or more of the features shown therein. Further, these embodiments may be combined with features, aspects, and/or implementations of any of the previous figures or otherwise described herein.

Block 1400 may involve generating, for display on a client device, a representation of a graphical user interface including a menu pane, a subtask pane, and a related information pane, wherein the menu pane is populated with a plurality of selectable objects representing a plurality of subtasks for a playbook, wherein persistent storage contains a definition of the playbook and the plurality of subtasks, and wherein at least some of the subtasks are respectively associated with corresponding data sources that can provide units of related information.

Block 1402 may involve transmitting, to the client device, the representation of the graphical user interface.

Block 1404 may involve receiving, from the client device, an indication that a particular selectable object of the plurality of selectable objects has been selected, wherein the particular selectable object represents a particular subtask of the plurality of subtasks.

Block 1406 may involve determining that a particular data source corresponding to the particular subtask can be used to provide a particular unit of the related information.

Block 1408 may involve obtaining, by way of the particular data source, the particular unit of the related information.

Block 1410 may involve updating the representation of the graphical user interface to include details of the particular subtask in the subtask pane, and to include the particular unit of the related information in the related information pane.

Block 1412 may involve transmitting, to the client device, the representation of the graphical user interface as updated.

In some embodiments, the persistent storage may include a database, wherein the particular data source is in the database.

In some embodiments, the particular data source is not in the persistent storage.

In some embodiments, the particular data source is a remote service accessible by way of an application programming interface, wherein obtaining the particular unit of the related information comprises: transmitting, to the application programming interface, a request for the particular unit of the related information; and receiving, from the application programming interface, the particular unit of the related information.

In some embodiments, the particular data source is a machine learning model, wherein obtaining the particular unit of the related information comprises: providing, to the machine learning model, input data; and receiving, from the machine learning model, the particular unit of the related information.

In some embodiments, the related information pane includes a menu icon that, when selected, causes appearance of a drop-down menu on the graphical user interface, wherein the drop-down menu contains labels for a plurality of different types of the related information, and wherein selection of any of the labels causes the related information pane to display at least some of the units of related information of the associated type.

Some embodiments may further involve: receiving, from the client device, a second indication that a second particular selectable object of the plurality of selectable objects has been selected, wherein the second particular selectable object represents a second particular subtask of the plurality of subtasks; determining that a second particular data source corresponding to the second particular subtask can be used to provide a second particular unit of the related information; obtaining, by way of the second particular data source, the second particular unit of the related information; updating further the representation of the graphical user interface to include details of the second particular subtask in the subtask pane, and to include the second particular unit of the related information in the related information pane; and transmitting, to the client device, the representation of the graphical user interface as updated further.

In some embodiments, determining that the particular data source can be used to provide the particular unit of the related information comprises reading, from the persistent storage, a configuration for the playbook that maps the subtasks to their corresponding data sources.

In some embodiments, the configuration comprises a subtask definition, and a related information processing definition, wherein the subtask definition specifies the particular subtask and the particular data source, wherein related information processing definition specifies a filter, and wherein obtaining the particular unit of the related information comprises applying the filter to the particular unit of the related information.

In some embodiments, the configuration also comprises a relationship definition that associates the subtask definition with the related information processing definition.

In some embodiments, the subtask definition, the related information processing definition, and the relationship definition are implemented as entries in respective database tables.

In some embodiments, the subtask definition also specifies script logic, wherein obtaining the particular unit of the related information further comprises executing the script logic to formulate the particular unit of the related information.

### VII. CLOSING

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical operations or actions in the method or technique. The program code and/or related data can be stored on any type of computer readable medium such as a storage device including RAM, a disk drive, a solid-state drive, or another storage medium.

The computer readable medium can also include non-transitory computer readable media such as non-transitory computer readable media that store data for short periods of time like register memory and processor cache. The non-transitory computer readable media can further include non-transitory computer readable media that store program code and/or data for longer periods of time. Thus, the non-transitory computer readable media may include secondary or persistent long-term storage, like ROM, optical or magnetic disks, solid-state drives, or compact disc read only memory (CD-ROM), for example. The non-transitory computer readable media can also be any other volatile or non-volatile storage systems. A non-transitory computer readable medium can be considered a computer readable storage medium, for example, or a tangible storage device.

Moreover, a step or block that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments could include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

What is claimed is:

1. A system comprising:
persistent storage containing a definition of a playbook and a plurality of subtasks for the playbook, wherein at least some of the subtasks are respectively associated with corresponding data sources that can provide units of related information; and
one or more processors configured to:
generate, for display on a client device, a representation of a graphical user interface including a menu pane, a subtask pane, and a related information pane, wherein the menu pane is populated with a plurality of selectable objects representing the plurality of subtasks;
transmit, to the client device, the representation of the graphical user interface;
receive, from the client device, an indication that a particular selectable object of the plurality of selectable objects has been selected, wherein the particular selectable object represents a particular subtask of the plurality of subtasks;
determine that a particular data source corresponding to the particular subtask can be used to provide a particular unit of the related information;
obtain, by way of the particular data source, the particular unit of the related information;
update the representation of the graphical user interface to include details of the particular subtask in the subtask pane, and to include the particular unit of the related information in the related information pane; and
transmit, to the client device, the representation of the graphical user interface as updated.

2. The system of claim 1, further comprising:
a database, wherein the particular data source is in the database.

3. The system of claim 1, wherein the particular data source is not in the persistent storage.

4. The system of claim 1, wherein the particular data source is a remote service accessible by way of an application programming interface, and wherein obtaining the particular unit of the related information comprises:
transmitting, to the application programming interface, a request for the particular unit of the related information; and
receiving, from the application programming interface, the particular unit of the related information.

5. The system of claim 1, wherein the particular data source is a machine learning model, and wherein obtaining the particular unit of the related information comprises:
providing, to the machine learning model, input data; and
receiving, from the machine learning model, the particular unit of the related information.

6. The system of claim 1, wherein the related information pane includes a menu icon that, when selected, causes appearance of a drop-down menu on the graphical user interface, wherein the drop-down menu contains labels for a plurality of different types of the related information, and wherein selection of any of the labels causes the related information pane to display at least some of the units of related information of the associated type.

7. The system of claim 1, wherein the one or more processors are further configured to:
receive, from the client device, a second indication that a second particular selectable object of the plurality of selectable objects has been selected, wherein the second particular selectable object represents a second particular subtask of the plurality of subtasks;
determine that a second particular data source corresponding to the second particular subtask can be used to provide a second particular unit of the related information;
obtain, by way of the second particular data source, the second particular unit of the related information;
update further the representation of the graphical user interface to include details of the second particular subtask in the subtask pane, and to include the second particular unit of the related information in the related information pane; and
transmit, to the client device, the representation of the graphical user interface as updated further.

8. The system of claim 1, wherein determining that the particular data source can be used to provide the particular unit of the related information comprises:
reading, from the persistent storage, a configuration for the playbook that maps the subtasks to their corresponding data sources.

9. The system of claim 8, wherein the configuration comprises a subtask definition, and a related information processing definition, wherein the subtask definition specifies the particular subtask and the particular data source, wherein related information processing definition specifies a filter, and wherein obtaining the particular unit of the related information comprises applying the filter to the particular unit of the related information.

10. The system of claim 9, wherein the configuration also comprises a relationship definition that associates the subtask definition with the related information processing definition.

11. The system of claim 10, wherein the subtask definition, the related information processing definition, and the relationship definition are implemented as entries in respective database tables.

12. The system of claim 9, wherein the subtask definition also specifies script logic, and wherein obtaining the particular unit of the related information further comprises executing the script logic to formulate the particular unit of the related information.

13. A computer-implemented method comprising:
generating, for display on a client device, a representation of a graphical user interface including a menu pane, a subtask pane, and a related information pane, wherein the menu pane is populated with a plurality of selectable objects representing a plurality of subtasks for a playbook, wherein persistent storage contains a definition of the playbook and the plurality of subtasks, and wherein at least some of the subtasks are respectively associated with corresponding data sources that can provide units of related information;
transmitting, to the client device, the representation of the graphical user interface;
receiving, from the client device, an indication that a particular selectable object of the plurality of selectable objects has been selected, wherein the particular selectable object represents a particular subtask of the plurality of subtasks;
determining that a particular data source corresponding to the particular subtask can be used to provide a particular unit of the related information;
obtaining, by way of the particular data source, the particular unit of the related information;
updating the representation of the graphical user interface to include details of the particular subtask in the subtask pane, and to include the particular unit of the related information in the related information pane; and
transmitting, to the client device, the representation of the graphical user interface as updated.

14. The computer-implemented method of claim 13, wherein the related information pane includes a menu icon that, when selected, causes appearance of a drop-down menu on the graphical user interface, wherein the drop-down menu contains labels for a plurality of different types of the related information, and wherein selection of any of the labels causes the related information pane to display at least some of the units of related information of the associated type.

15. The computer-implemented method of claim 13, wherein determining that the particular data source can be used to provide the particular unit of the related information comprises:
reading, from the persistent storage, a configuration for the playbook that maps the subtasks to their corresponding data sources.

16. The computer-implemented method of claim 15, wherein the configuration comprises a subtask definition, and a related information processing definition, wherein the subtask definition specifies the particular subtask and the particular data source, wherein related information processing definition specifies a filter, and wherein obtaining the particular unit of the related information comprises applying the filter to the particular unit of the related information.

17. The computer-implemented method of claim 16, wherein the configuration also comprises a relationship definition that associates the subtask definition with the related information processing definition.

18. The computer-implemented method of claim 17, wherein the subtask definition, the related information processing definition, and the relationship definition are implemented as entries in respective database tables.

19. The computer-implemented method of claim 16, wherein the subtask definition also specifies script logic, and wherein obtaining the particular unit of the related information further comprises executing the script logic to formulate the particular unit of the related information.

20. An article of manufacture including a non-transitory computer-readable medium, having stored thereon program instructions that, upon execution by a computing system, cause the computing system to perform operations comprising:
generating, for display on a client device, a representation of a graphical user interface including a menu pane, a subtask pane, and a related information pane, wherein the menu pane is populated with a plurality of selectable objects representing a plurality of subtasks for a playbook, wherein persistent storage contains a definition of the playbook and the plurality of subtasks, and wherein at least some of the subtasks are respectively associated with corresponding data sources that can provide units of related information;
transmitting, to the client device, the representation of the graphical user interface;
receiving, from the client device, an indication that a particular selectable object of the plurality of selectable objects has been selected, wherein the particular selectable object represents a particular subtask of the plurality of subtasks;
determining that a particular data source corresponding to the particular subtask can be used to provide a particular unit of the related information;
obtaining, by way of the particular data source, the particular unit of the related information;
updating the representation of the graphical user interface to include details of the particular subtask in the subtask pane, and to include the particular unit of the related information in the related information pane; and
transmitting, to the client device, the representation of the graphical user interface as updated.
